(19) United States
(12) Patent Application Publication
(10) Pub. No.: US 2024/0003317 A1
(43) Pub. Date: Jan. 4, 2024

(54) Propulsor Fan

(71) Applicant: Whisper Aero Inc., Crossville, TN (US)

(72) Inventors: Gabriel L. Suciu, Glastonbury, CT (US); Matthew Alan Dempsey, Crossville, TN (US); Andy Le, Garden Grove, CA (US); Devon Jedamski, Crossville, TN (US); Wesley Kenneth Lord, South Glastonbury, CT (US)

(21) Appl. No.: 18/208,158

(22) Filed: Jun. 9, 2023

Related U.S. Application Data
(60) Provisional application No. 63/356,852, filed on Jun. 29, 2022.

(51) Int. Cl. F02K 3/04; F01D 5/30; F01D 11/08

(52) U.S. Cl. CPC F02K 3/04; F01D 5/30; F01D 11/08

(57) ABSTRACT

A propulsor fan and drive system having reduced noise emission is disclosed. The propulsor fan includes a blade fan having a plurality of blades. The blades may include a dual pin-root design to secure the blade fan to a hub and a shroud at tips of the blades. The blades may include one or more knife edge seals that protrude from a surface of the shroud.

### CROSS-REFERENCE TO RELATED APPLICATION

This application claims priority to U.S. Provisional Patent Application No. 63/356,852 filed on Jun. 29, 2022, which is hereby incorporated by reference in its entirety.

### BACKGROUND

### Field of Technology

The present disclosure generally relates to a propulsor fan and drive system, and more particularly to a tensioned bladed fan with one or more knife edge seals.

### Description of the Related Art

Conventional propulsor fans typically include open rotors and propellers. These types of conventional propulsor fans have reached their acoustic limits. Conventional propulsor have blades that are supported on a single end thereby limiting the blade count to five or less blades. For conventional propulsors to emit sound that is at a frequency that is less perceivable to the human ear, the speed of the fans must be increased. However, conventional propulsors cannot be driven at a higher speed due to being only supported by the single end structure. Furthermore, since conventional propulsor fans are supported only at a single end, the angle of the fan blades may change as the blade fan spins at faster speeds which results in changes in pitch that is audible to the human ear. As a result, noise pollution is increased. The noise pollution is increased further as the conventional propulsor fan is integrated into an array of multiple conventional propulsor fans.

Furthermore, conventional fan designs incorporated into conventional propulsor fans are aimed at moderate to high fan pressure ratio (PR) applications (1.3 PR to 1.75 PR). Typically, the lower the fan PR, the lower the fan aspect ratio (AR). As a result, high aspect ratio blades with high pressure ratio fans and are made of titanium (or stronger materials). For structural reasons, these conventional fan designs include one or two part span shrouds to control the vibratory modes of the fan blade. This results in reduced fan performance (approx. 1% loss if one part span shroud was required, and twice that if two were required). For example, open tip clearances used in conventional fan designs further degrade fan performance since conventional fan designs are designed to rub on abradable material over time from maneuvers, hard landings, and erosion.

### SUMMARY

A propulsor fan having reduced noise emission is disclosed. The propulsor fan includes a blade fan having a plurality of blades. The plurality of blades have an interlocking tip shroud design to restrict the airfoil angle of attack movement as well as to increase the structural stiffness of the airfoil at high revolutions per minute (RPM).

In one embodiment, the tips of the blade fan are tensioned using an interlocking tip design such that a pitch of the blades during thrust generation is substantially the same as a pitch of the blades at rest. Each blade includes a shroud segment that is configured to connect to shroud segments of other blades. The connected shroud segments collectively form the tip shroud around the circumference of the blade fan and tension the tips of the blades. By tensioning the tips of the blades, a same shape and twist of the blades are maintained during thrust generation and at rest thereby reducing noise that may result from changes in the angle of the blades.

In one embodiment, each blade may also include a plurality of knife edge segments that protrude from an upper surface of the blade's shroud segment. The knife edge segments of each blade are configured to connect to knife edge segments of other blades. The connected knife edge segments collectively form one or more knife edge seals around the circumference of the tip shroud. The knife edge seal(s) improve control of tip leakage and provide improved fan blade clearance-to-span for improved performance and retention.

In one embodiment, each blade comprises a pin-root structure to connect the blade to a hub. The pin-root structure may include a plurality of mounting tabs that are offset from each other. The mounting tabs of each blade are inserted into the hub and connected to the hub using a plurality of fasteners. Due to the offset of the mounting tabs of each blade, a plurality of fasteners are used to connect each blade to the hub where each fastener connects a plurality of blades to the hub. By tensioning the roots of the blades, a same shape and twist of the blades are maintained during thrust generation and at rest thereby reducing noise that may result from changes in the angle of the blades.

### BRIEF DESCRIPTION OF DRAWINGS

FIG. 1 is a perspective view of a propulsor fan according to one embodiment.

FIG. 2A is a first exploded view of the propulsor fan according to one embodiment.

FIG. 2B is a second exploded view of the propulsor fan according to one embodiment.

FIGS. 3A, 3B, 3C, and 3D respectively illustrate a perspective view, a front view, a side view, and a cross-section view of a duct lip of the propulsor fan according to one embodiment.

FIGS. 4A, 4B, 4C, and 4D respectively illustrate a perspective view, a front view, a cross-section view, and a perspective view of the cross-section of a nose cone of the propulsor fan according to one embodiment.

FIGS. 5A and 5B respectively illustrate a front view and a side view of a hub of the propulsor fan according to a second embodiment.

FIGS. 6A and 6B respectively illustrate a perspective view and a front view of a blade fan of the propulsor fan according to one embodiment.

FIGS. 7A, 7B, 7C, and 7D respectively illustrate a perspective view, a front view, a side view, and a top view of a blade included in the blade fan shown in FIGS. 6A and 6B according to a first embodiment.

FIGS. 8A, 8B, and 8C respectively illustrate a perspective view, a front view, and a side view of a locking ring of the propulsor fan according to one embodiment.

FIGS. 9A and 9B respectively illustrate a perspective view and a side view of a tension ring of the propulsor fan according to one embodiment.

FIGS. 10A, 10B, and 10C respectively illustrate a perspective view, a front view, and a side view of an inner duct body housing of the propulsor fan according to one embodiment.

FIGS. 11A, 11B, 11C, and 11D respectively illustrate a perspective view, a front view, a side view, and a cross section view of a stator of the propulsor fan according to one embodiment.

FIGS. 12A, 12B, 12C, and 12D respectively illustrate a perspective view, a front view, a side view, and a cross section view of a tail cone of the propulsor fan according to one embodiment.

FIGS. 13A, 13B, and 13C respectively illustrate a perspective view, a front view, and a side view of a circumferential drive system of the propulsor fan according to one embodiment.

FIG. 14 illustrates a circumferential drive system of the propulsor fan according to another embodiment.

FIGS. 15A and 15B respectively illustrate a front view and a perspective view of an array of propulsor fans according to one embodiment.

FIG. 16 illustrates an example application of an array of propulsor fans according to one embodiment.

FIGS. 17A, 17B, and 17C respectively illustrate a front view, a side view, and a top view of a hover drone including an array of propulsor fans according to one embodiment.

FIGS. 18A, 18B, and 18C respectively illustrate a front view, a side view, and a top view of a cinema drone including an array of propulsor fans according to one embodiment.

FIGS. 19A, 19B, and 19C respectively illustrate a front view, a side view, and a top view of a transporter aircraft including an array of propulsor fans according to one embodiment.

FIGS. 20A, 20B, and 20C respectively illustrate a front view, a side view, and a top view of a vertical takeoff and landing (VTOL) aircraft including an array of propulsor fans according to one embodiment.

FIGS. 21A, 21B, and 21C respectively illustrate a front view, a side view, and a top view of a delivery drone including an array of propulsor fans according to one embodiment.

FIGS. 22A, 22B, and 22C respectively illustrate a front view, a side view, and a top view of a blade with a dual pin-root according to a second embodiment.

FIG. 23A is a perspective view of the blade with the dual pin-root shown in FIGS. 22A to 22C according to the second embodiment.

FIG. 23B is a perspective view of a shroud segment of the blade with the dual pin-root shown in FIGS. 22A to 22C according to the second embodiment.

FIG. 23C is a perspective view of the dual pin-root shown in FIGS. 22A to 22C according to the second embodiment.

FIGS. 24A, 24B, and 24C respectively illustrate a front view, a side view, and a perspective view of a plurality of interconnected blades that form a portion of a tip shroud where each blade includes the dual pin-root according to the second embodiment.

FIGS. 25A and 25B respectively illustrates a front view and a perspective view of a plurality of knife edge segments on a shroud segment of a blade according to one embodiment.

FIG. 26A illustrates a front view of a plurality of knife edge segments on the shroud segment of a blade with different heights according to the one embodiment.

FIG. 26B illustrates a front view of a single knife edge segment on the shroud of a blade according to one embodiment.

FIGS. 27A and 27B respectively illustrate a front view and a side view of a hub according to a second embodiment.

FIGS. 28A and 28B respectively illustrate a perspective view of a first end of the hub and a perspective view of a second end of the hub shown in FIGS. 27A and 27B according to the second embodiment.

FIG. 29 is a cross-section view of the hub along line A-A′ in FIG. 27B according to the second embodiment.

FIGS. 30A, 30B, and 30C respectively illustrate a front view, a side view, and a perspective view of a blade with the dual pin hole root that is connected to the hub of FIGS. 28A and 28B according to one embodiment.

FIGS. 31A and 31B respectively illustrate a perspective view and a side view of a plurality of interconnected blades with the dual pin hole root that are connected to the hub of FIGS. 28A and 28B according to one embodiment.

FIGS. 32A and 32B respectively illustrate a detailed perspective view of region A of FIG. 31A of a first end of the hub with the plurality of interconnected blades connected to the hub using a plurality of fasteners and a detailed perspective view of region A of FIG. 31A of a second end of the hub with the plurality of interconnected blades connected to the hub using the plurality of fasteners according to one embodiment.

FIG. 33 is a wire frame view of a plurality of interconnected blades with the dual pin root that are connected to the hub using a plurality of fasteners according to one embodiment.

FIGS. 34A, 34B, and 34C respectively illustrate a front view, a side view, and a perspective view of a blade fan with a tip shroud using blades with the dual pin hole root according to one embodiment.

FIGS. 35A, 35B, and 35C respectively illustrate a front view, a side view, and a perspective view of a blade fan with a tip shroud and a plurality of knife edge seals using blades with the dual pin hole root according to one embodiment.

FIG. 36 illustrates a perspective view of a blade fan with a tip shroud and a single knife edge seal according to one embodiment.

FIGS. 37A and 37B respectively illustrate a side view and a perspective view of a blade with a plurality of knife edge segments and a single pin hole root according to a third embodiment.

FIG. 38 illustrates a front view of a blade fan with the single pin hole root and a plurality of knife edge seals according to one embodiment DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

Propulsor Fan and Drive System

In one embodiment, a propulsor fan and drive system is disclosed. Generally, the propulsor fan and drive system are configured to generate thrust. The propulsor fan and drive system may generate thrust for various applications from aircraft to hand tools such as a leaf blower. However, the applications of the propulsor fan and drive system are not limited those described herein.

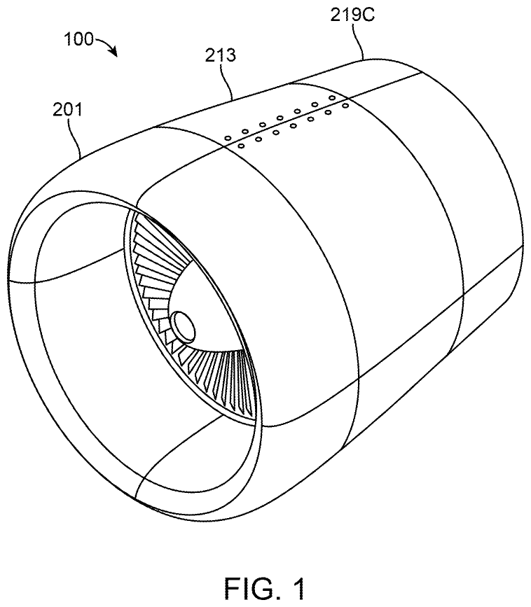

FIG. 1 illustrates a perspective view of a propulsor fan 100 according to one embodiment. Generally, the propulsor fan 100 includes a plurality of components that collectively reduce noise emitted by the propulsor fan 100 during thrust generation. Thus, the propulsor fan 100 reduces noise pollution. For example, the propulsor fan 100 includes a tensioned blade fan that includes a plurality of fan blades. By tensioning the blade fan, the angle of the fan blades is maintained to be substantially the same whether the propulsor fan is generating maximum thrust or is not operating (e.g., is at rest). As a result, noise pollution is reduced and thrust efficiency is increased compared to conventional propulsor fans. The propulsor fan 100 reduces noise pollution given that the angle of the fan blades is maintained within a predetermined tolerance range. For example, the propulsor fan 100 emits noise that is less than 65 dBA at 300 feet sideline/5,000 lbf.

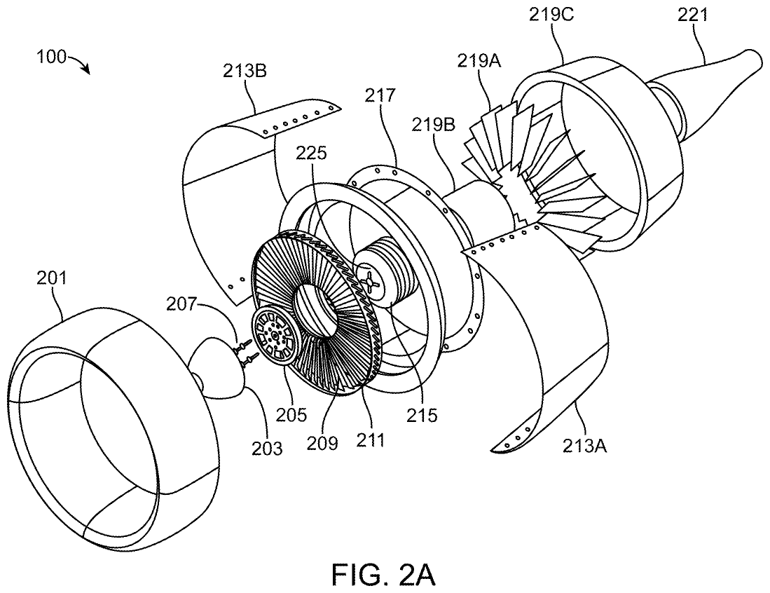

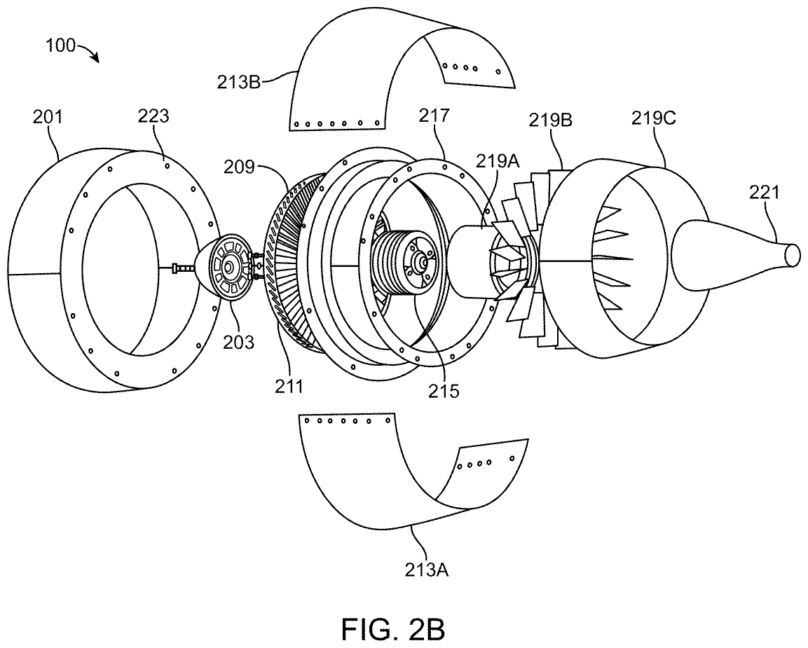

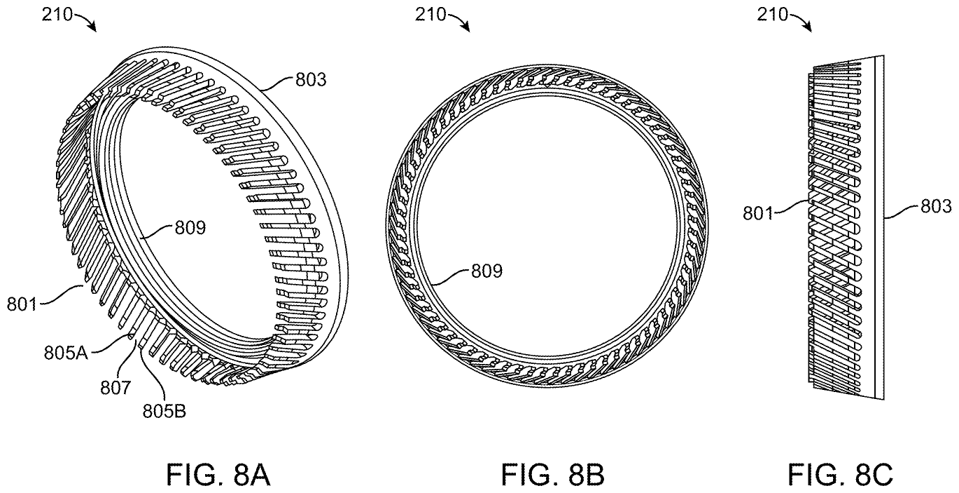

FIG. 2A illustrates a first exploded view of the propulsor fan 100 and FIG. 2B illustrates a second exploded view of the propulsor fan 100 according to one embodiment. The propulsor fan 100 includes a plurality of different components as shown in FIGS. 2A and 2B. In one embodiment, the propulsor fan 100 includes a duct lip 201, a nose cone 203, a hub 205, a blade fan 209, a locking ring 210 (shown in FIGS. 8A to 8C), a tension ring 211, a motor 215, a body housing 217, a plurality of outer casings 213A and 213B, a stator 219, and a tail cone 221. Other embodiments of the propulsor fan 100 may include other components than shown in FIGS. 2A and 2B. In one embodiment, the duct lip 201, the outer casings 213, and a portion of the stator 219 (e.g., 219C) collectively form a circulation duct that houses the components of the propulsor fan, as shown in FIG. 1.

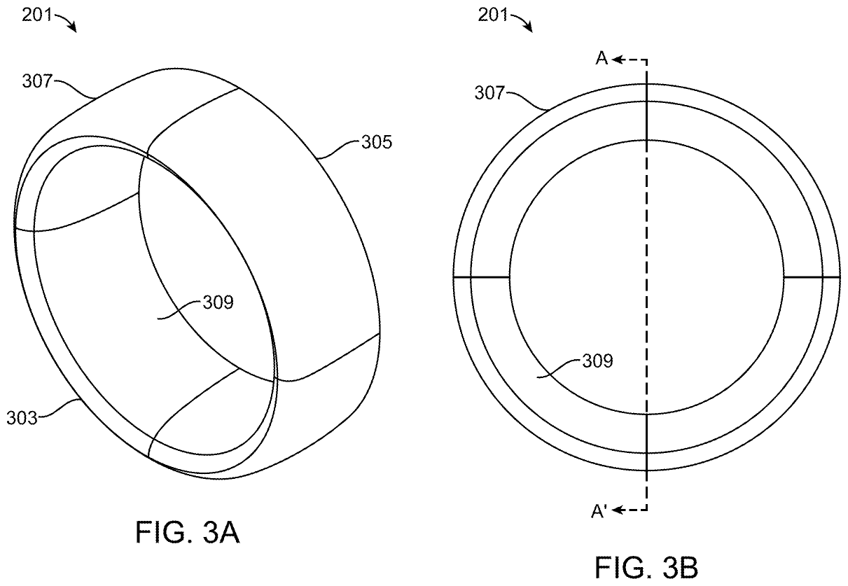

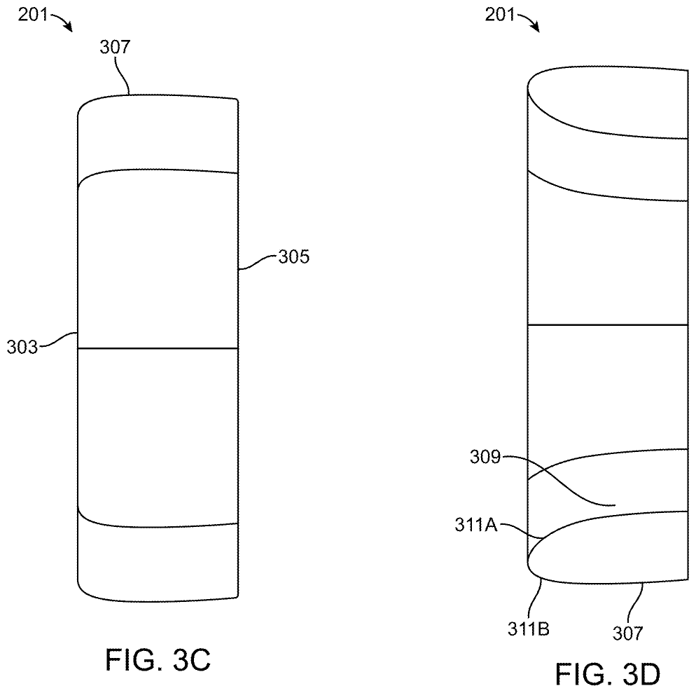

FIGS. 3A, 3B, 3C, and 3D respectively illustrate a perspective view, a front view, a side view, and a cross-section view of a duct lip 201 of the propulsor fan 100 according to one embodiment. In one embodiment, the duct lip 201 is configured to provide a clean inflow of air to the propulsor fan 100. The duct lip 201 is configured to connect to the body housing 217 in one embodiment. The duct lip 201 may include a plurality of mounting holes 223 on a rear surface of the duct lip 201 as shown in FIG. 2B. Fasteners (e.g., nuts and bolts, rivets, etc.) are placed in the mounting holes 223 to connect the duct lip 201 to a first end 1001 of the body housing 217 as will be further described below.

The duct lip 201 may comprise a plurality of panels that collectively form the duct lip 201. For example, the duct lip 201 may include a first plurality of panels that collectively form an inner surface 309 of the duct lip 201 and include a second plurality of panels that collectively form an outer surface 307 of the duct lip 201 such that the duct lip 201 has a hollow center through which air is channeled to the blade fan 209. The first and second plurality of panels may be connected to each other via various fastening means such as fasteners (e.g., screws, nuts, bolts) or via welding. The first and second plurality of panels may be made of metal such as aluminum or titanium or composite such as carbon fiber. Alternatively, the duct lip 201 may be made of a single piece of material and may be 3D printed for example.

In one embodiment, the duct lip 201 includes a first end 303 (e.g., an inlet) and a second end 305 (e.g., an outlet). The first end 303 receives air and the air exits the second end 305. As shown in FIG. 3C, a diameter of the first end 303 is less than a diameter of the second end 305, but may be the same in other embodiments. The diameters of the first end 303 and second end 305 of duct lip 201 are dependent on the application of the propulsor fan 100. For example, the diameters of the first end 303 and the second 305 of the duct lip 201 are larger for aircraft applications compared to leaf blower applications.

FIG. 3D is a cross-section view of the duct lip 201 along plane A-A′ shown in FIG. 3B according to one embodiment. As mentioned previously, the duct lip 201 includes an outer surface 307 and an inner surface 309. The outer surface 307 and the inner surface 309 both extend from the first end 303 of the duct lip 201 towards the second end 305 of the duct lip 201. Air flows through the inner surface 309 of the duct lip 201. A curvature 311A of the inner surface 309 of the duct lip 201 and a curvature 311B of the outer surface 307 of the duct lip 301 are designed to balance various factors such as different conditions (e.g., flying conditions such as cruise, takeoff, and landing) and Reynolds number. Those skilled in the art will be able to tailor the duct lip radius for favorable pressure gradients across speed regimes and flight modes of interest.

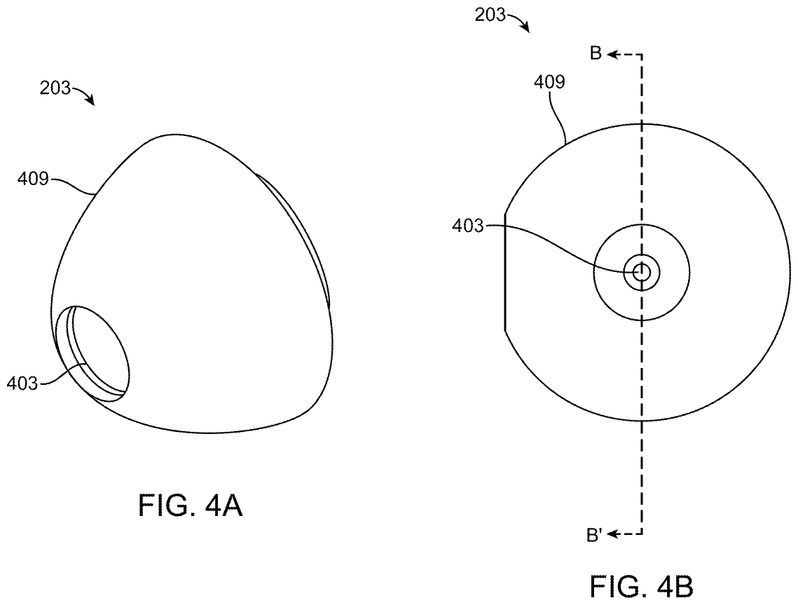

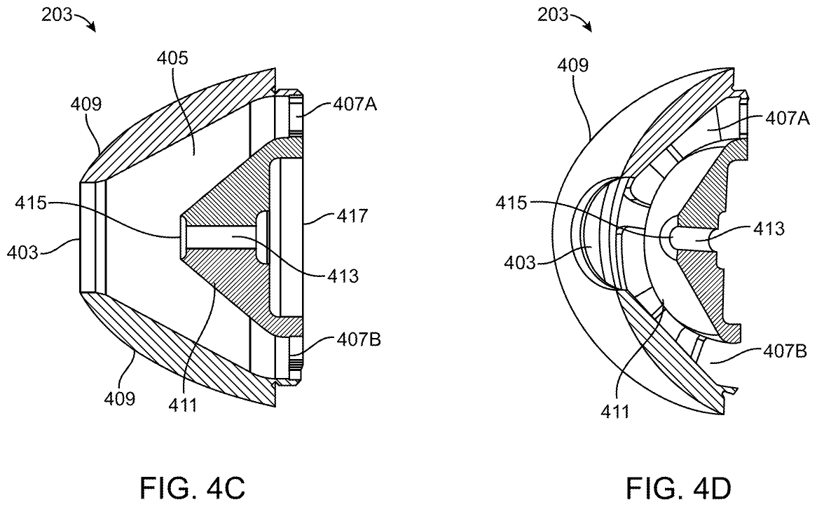

FIGS. 4A, 4B, 4C, and 4D respectively illustrate a perspective view, a front view, a cross-section view, and a perspective view of the cross-section of a nose cone 203 of the propulsor fan 100 according to one embodiment. The nose cone 203 is configured to modulate oncoming airflow behavior and reduce aerodynamic drag. The nose cone 203 may also be configured with an impeller to aid in cooling air mass flow without contributing significantly to broadband or tonal noise.

In one embodiment, the nose cone 203 is configured to connect to the motor 215 with the hub 205 disposed between the nose cone 203 and the motor 215. The nose cone 203 may include a plurality of mounting holes on a rear surface of the nose cone 203 as shown in FIG. 2B. Fasteners 207 (e.g., nuts and bolts, rivets, etc.) are placed in the mounting holes to connect the nose cone 203 to a first end of the hub 205. As will be further described below, the fasteners 207 extend through the hub 205 and connect to a first end of the motor 215.

In one embodiment, the nose cone 203 is conical in shape. However, the nose cone 203 can have different shapes in other embodiments. As shown in FIGS. 4A to 4D, the nose cone 203 includes an opening 403 (e.g., a hole) at a first end of the nose cone 203. As the blade fan 209 spins, air is pulled through the opening 403 in the nose cone 203 to cool the motor 215. The secondary mass flow required to cool inner components sizes the inner diameter of the nose cone 203 opening 403. Those skilled in the art will be able to derive this diameter subject to thermal requirements of different electric motors and the air required to cool them at the most constraining condition, typically max continuous operation.

FIG. 4C is a cross-section view of the nose cone 203 along plane B-B′ shown in FIG. 4B according to one embodiment. In one embodiment, the nose cone 203 is not solid and includes a cavity. For example, the nose cone 203 comprises an air channel 405 in one embodiment. The air channel 405 extends from the opening 403 in the nose cone 203 to a plurality of openings 407 that are disposed around the circumference of the second end (e.g., the rear surface) of the nose cone 203. Air flows from the opening 403 through the air channel 405 and exits the plurality of openings 407 to cool the motor 215. In one embodiment, the air channel 405 is formed between an outer surface 409 of the nose cone 203 and a protrusion 411 formed within the nose cone 211 as shown in FIG. 4C and FIG. 4D.

In one embodiment, the protrusion 411 protrudes from the second end of the nose cone 203 inward towards the opening 403 of the nose cone 203. The protrusion 411 may have a similar shape as the nose cone 203. For example, the protrusion 411 is also conically shaped. However, in other embodiments the protrusion 411 may have a different shape than the nose cone 203.

Generally, the protrusion 411 has a size and shape that is tuned for mass air flow to cool the motor 215. In one embodiment, the protrusion 411 includes an air channel 413 formed through the protrusion 411 through which air flows from an opening 415 of the air channel 413 to an opening 417 on the second end of the nose cone 203. In one embodiment, a center of the air channel 413 is aligned with a center of the opening 403 in the nose cone 203.

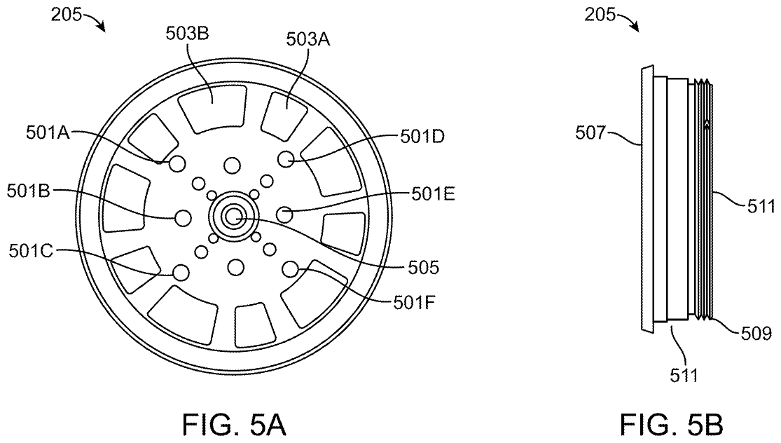

FIGS. 5A and 5B respectively illustrate a front view and a side view of a hub 205 of the propulsor fan 100 according to a first embodiment. The hub 205 is the central portion of the propulsor fan 100 and is disposed at a center of the blade fan 209 as will be further described below. The hub 205 is configured to connect to the nose cone 203, the locking ring 210, and the motor 215 in one embodiment.

As shown in FIGS. 5A to 5C, the hub 205 is cylindrical in shape in one example. The diameter of a first end 507 of the hub 205 matches a diameter of the second end of the nose cone 203 in one embodiment. The first end 507 (e.g., a front surface) of the hub 205 includes a plurality of mounting holes 501A to 501F that are formed through a thickness of the hub 205. The position of the mounting holes 501 is such that the mounting holes 501 are aligned with the mounting holes of the nose cone 203 when the second end of the nose cone 203 is mated to the first end 507 of the nose hub 205. The fasteners 207 are configured to pass through the mounting holes 501A to 501F and connect to a first end (e.g., a front surface) of the motor 215. For example, the fasteners 207 screw into threaded holes 225 on the first end of the motor 215.

In one embodiment, the hub 205 also includes a plurality of openings 503 that extend through the thickness of the hub 205 such as openings 503A and 503B. The plurality of openings 503 have a shape and size that match (e.g., are the same) as the openings 407 in the rear surface of the nose cone 203. The openings 503 are configured to align with the openings 407 in the rear surface of the nose cone 203 when the nose cone 203 and the hub 205 are mated to each other. Thus, air exiting the openings 407 of the nose cone 203 flow through the openings 503 included in the hub 205. In one embodiment, the plurality of openings 503 included in the hub have different sizes. For example, opening 503A is smaller than opening 503B.

In one embodiment, the hub 205 also includes an opening 505 that extends through a thickness of the hub 205. The opening 505 is positioned at a center of the hub 205. In one embodiment, a center of the opening 205 is configured to be aligned with a center of the air channel 413 of the nose cone 203. Thus, air flow exiting the air channel 413 of the nose cone 203 flows through the opening 505 in the hub 205 to cool the motor 215.

In one embodiment, a second end 511 of the hub 205 that is opposite the first end 507 includes a connection mechanism 509 around the outer circumference of the second end 511 of the hub 205. The connection mechanism 509 is configured to connect the hub 205 to the locking ring 210. In one embodiment, the connection mechanism 509 is threads such that the hub 205 screws into the locking ring 210. Once the hub 205 is connected to the locking ring 210, the locking ring 210 surrounds the outer circumference of the hub 205. The motor 215 is configured to mate to the outer face of the second end 511 of the hub 211.

In one embodiment, the hub 205 includes an intermediate area 511 disposed between the first end 507 and second end 511 of the hub 205. In one embodiment, the blade fan 209 is configured to be disposed around the circumference of the intermediate area 511 while the hub 205 is placed through a center of the blade fan 209.

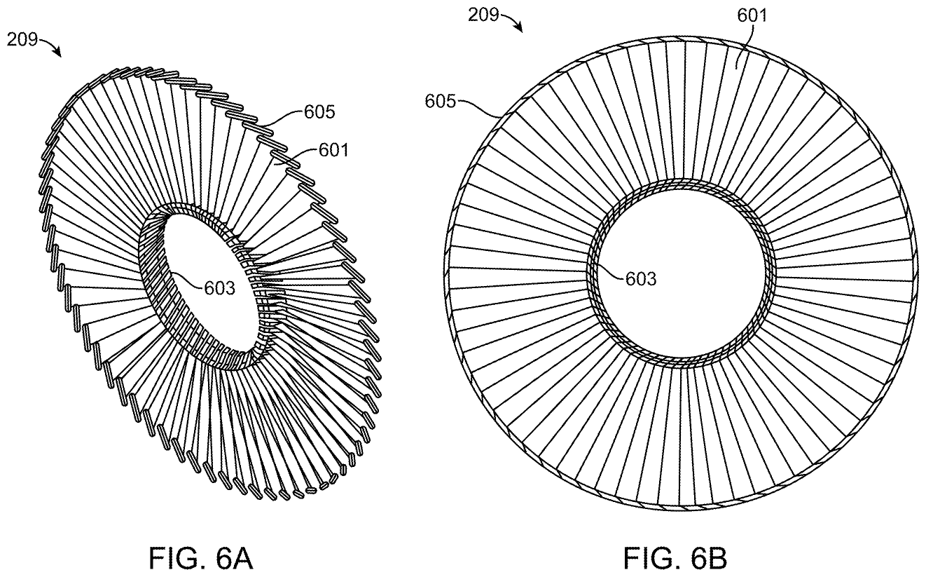

FIGS. 6A and 6B respectively illustrate a perspective view and a front view of a blade fan 209 of the propulsor fan 100 according to a first embodiment. As shown in FIGS. 6A to 6B, the blade fan 209 includes a plurality of blades 601. The total number of blades 601 included in the blade fan 209 is significantly more than the number of blades included in a conventional propulsor fan that has 2 to 5 blades. In one embodiment, the blade fan 209 may include a range of blades 601 from 20 blades to an upper range of 100 to 150 blades having a hub/tip ratio (H/t) of 0.3 to 0.5. However, any number of blades greater than five can be used. Generally, the total number of blades 601 included in the blade fan 209 is dependent on the application. In one embodiment, the material for the blades of the many-bladed fan is also dependent on the type of application of the many-bladed fan. The blades may be made of metal such as aluminum or titanium or a composite such as carbon fiber.

In one embodiment, the blade fan 209 reduces overall blade noise as the blade fan 209 spins at a low tip speed (around 300-450 ft/sec). As described herein, the tensioned fan blade 209 allows many more blades to exist within mechanical material limits and still achieve ultrasonic signatures and low subsonic tip speeds. Furthermore, the higher number of blades 601 raises the tonal noise into ultrasonic frequencies outside the upper limit of human audibility (>16,000 Hz for typical adults). Furthermore, the low blade loading due to the higher blade count also reduces the severity of vortex-to-vortex collisions which cause broadband noise.

As shown in FIGS. 6A and 6B, the plurality of blades 601 are arranged to form a circular ring shape with a hollow center where the hub 205 is disposed. Each blade 601 is positioned such that at least a portion of the leading edge and trailing edge of the blade 601 are overlapped by neighboring blades 601. For example, a leading edge of a given blade is overlapped by the trailing edge of a blade to the left of the given blade and a trailing edge of the given blade is overlapped by a leading edge of a blade to the right of the given blade. The overlapping arrangement of the plurality of blades 601 provides increased solidity to perform work on the incoming stream of air. Tuning of this solidity takes into account localized aerodynamic effects and can be tuned to account for Reynolds number effects that may affect laminar attachment of flow in and between blades.

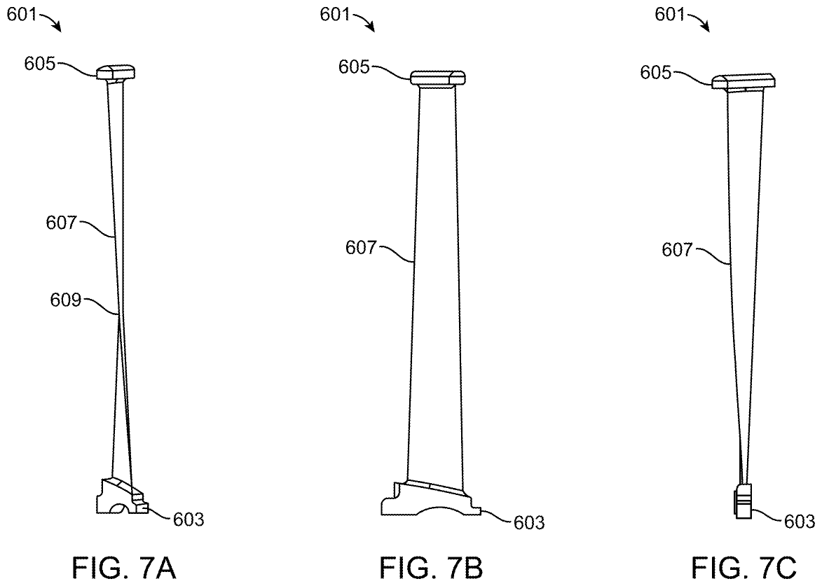

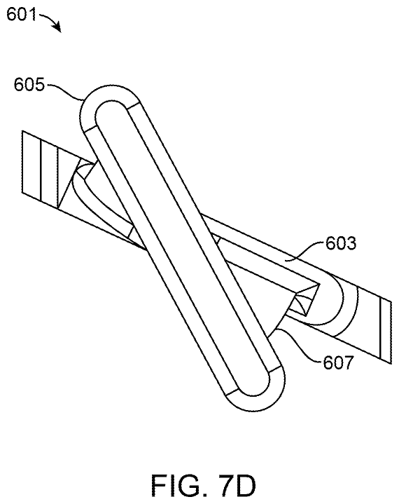

FIGS. 7A, 7B, 7C, and 7D respectively illustrate a perspective view, a front view, a side view, and a top view of a blade 601 included in the blade fan 209 shown in FIGS. 6A and 6B according to a first embodiment. In one embodiment, each blade 601 comprises a first locking end 605, a second locking end 603, and an airfoil 607 disposed between the first locking end 605 and the second locking end 603. The blade 601 may include other features than those described herein in other embodiments.

In one embodiment, the first locking end 605 is located at the tip of the blade 601. The first locking end 605 is configured to be inserted into the tension ring 211 and lock the blade 601 into the tension ring 211 such that the tip of the blade 601 is tensioned. By tensioning the tips of the blades 601, the pitch (e.g., angle) of the tips of the blades 601 is substantially the same during thrust generation or while the propulsor fan 100 is at rest thereby reducing noise pollution.

As shown in FIGS. 7A to 7D, the first locking end 605 is rectangular in shape with chamfered edges, but other shapes can be used for the first locking end 605. In one embodiment, the first locking end 605 has a width and thickness that is greater than a width and thickness of the tip of the airfoil 607. However, in other embodiments the first locking end 605 may be the same width or narrower than the tip of the blade 601. Those skilled in the art will tailor edges, chamfers, surfacing, and bezeling to account for localized stresses and strains due to tensioning.

In one embodiment, the second locking end 603 is located at the root of the blade 601. The second locking end 606 is configured to be inserted into the locking ring 210 and lock the blade 601 into the locking ring 210. By tensioning the roots of the blades 601, the pitch (e.g., angle) of the roots of the blades 601 is substantially the same during thrust generation or while the propulsor fan 100 is at rest thereby reducing noise pollution. As shown in FIGS. 7A to 7D, the second locking end 603 has a plurality of different surfaces (e.g., straight surfaces and curved surfaces) to increase the surface area that contacts the locking ring 210 to reduce blade deflection. In one embodiment, the second locking end 603 has a width that is greater than the root of the blade 601 and is wider than a width of the first locking end 605. However, in other embodiments the second locking end 603 may be the same width or narrower than the root of the blade 601.

The airfoil 607 is disposed between the first locking end 605 and the second locking end 603. In one embodiment, the airfoil 607 comprises a geometric twist 609 in the airfoil 607. The geometric twist 609 is a change in airfoil angle of incidence measured with respect to the root of the blade 601. That is, the airfoil 607 includes a plurality of different angles of incidence across the length of the airfoil 6077 due to the geometric twist 609. For example, the airfoil 607 may have a first angle of incidence at a first side of the geometric twist 609 (e.g., below the geometric twist 609 in FIGS. 7A to 7C) and may have a second angle of incidence at a second side of the geometric twist 609 (e.g., above the geometric twist 609 in FIGS. 7A to 7C).

As a result of the geometric twist 609, the first locking end 605 and the second locking end 609 are misaligned from each other when viewed from the top view of the blade 601 as shown in FIG. 7D. In one embodiment, the geometric twist 609 begins at a portion of the airfoil 607 that is closer to the root of the blade 601 than the tip of the blade 601. The geometric twist 609 between the root and tip chord may vary as much as 45 degrees.

Referring back to FIGS. 6A, and 6B, in one embodiment the blades 601 are positioned such that the second locking ends 603 are arranged in parallel with respect to each other around a circumference thereby forming the hole at the center of the blade fan 209. As a result, the first locking ends 605 are also arranged in parallel with each other and the airfoil 607 of each blade 601 overlaps another airfoil of an adjacent blade 601 due to the geometric twist 609 in the airfoil 607.

FIGS. 8A, 8B, and 8C respectively illustrate a perspective view, a front view, and a side view of a locking ring 210 of the propulsor fan 100 according to one embodiment. Generally, the locking ring 210 is configured to connect to the blade fan 209 and the hub 205 and beneficially tensions the roots of the blades 601. Thus, the blades 601 of the blade fan 209 are tensioned at both the tips and the roots to maintain the angle of the blades 601 during operation. The locking ring 210 may be made of metal such as aluminum or titanium or a composite such as carbon fiber.

The locking ring 210 includes a first end 801 and a second end 803. In one embodiment, the first end 801 has a diameter that is less than a diameter of the second end 803 thereby forming a conical shape. The tailoring of this shape is dictated by the needs of the primary internal flow to the fan (i.e., not the cooling flow) and may also take into account any boundary layer pressure gradients along the center body in the presence of the fan. In one embodiment, the first end 801 of the locking ring 210 is configured to directly connect the blade fan 209 to the locking ring 210 thereby locking the blade fan 209 to the locking ring 210. The first end 801 of the locking ring 210 includes a plurality of locking teeth 805. In one embodiment, the locking teeth 805 are protrusions that extend from a body of the locking ring 210 at an angle with respect to a reference that is perpendicular to the second end 803 of the locking ring.

A plurality of slots 807 are formed between the locking teeth 805. For example, a slot 807 is formed between a pair of locking teeth including locking tooth 805A and locking tooth 805B. The slots 807 have a width and depth that match dimensions of the second locking ends 603 of the blade fan 209. The slots 807 extend partially through the thickness of the locking ring 210 such as ¾ of the thickness of the locking ring 210, for example.

In one embodiment, each of the plurality of slots 807 is configured to connect to a corresponding one of the plurality of blades 601 of the blade fan 209. In particular, the second locking end 603 of each blade 601 is inserted into one of the slots 807 thereby securing the blade 601 to the locking ring 210 through the direction contact of the surfaces of the second locking end 603 and the locking teeth 805 that form the slots. In one embodiment, a fastener such as an epoxy is also applied to the second locking end 603 of each blade 601 to further strengthen the connection between the blades 601 and the locking ring 210. By locking the second locking end 603 of the blades 601 to the locking ring 210, the pitch of the roots of the blades 601 is maintained to be substantially the same during thrust generation or at rest thereby reducing audible noise that is emitted from the propulsor fan 100 since changes in pitch can be perceivable to the human ear.

In one embodiment, the second end 803 of the locking ring 210 includes a connection mechanism 809 at an inner circumference of the second end 803 of the locking ring 210. The connection mechanism 809 is configured to connect the locking ring 210 to the connection mechanism 509 of the hub 205, for example. In one embodiment, the connection mechanism 809 is threads that match the threads of the connection mechanism 509 of the hub 205 thereby allowing the hub 205 to be screwed into the locking ring 210. Since the motor 215 is connected to the hub 205, the hub 205 spins thereby causing the locking ring 210 and the blade fan 209 to also spin.

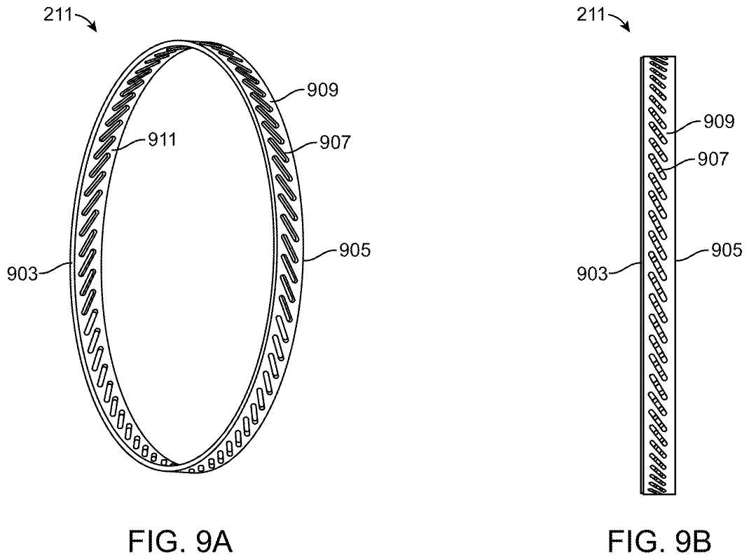

FIGS. 9A and 9B respectively illustrate a perspective view and a side view of a tension ring 211 of the propulsor fan 100 according to one embodiment. The tension ring 211 is configured to connect to the blade fan 209 by being placed around the circumference of the blade fan 209. More specifically, the tension ring 211 is configured to connect to all of the first locking ends 605 of the blade fan 209 according to one embodiment. By locking the first locking ends 605 of the blades 601 to the tension ring 211, the pitch of the tips of the blades 601 is maintained to be substantially the same during thrust generation and at rest thereby reducing audible noise that is emitted from the propulsor fan 100 since changes in pitch can be perceivable to the human ear. Thus, pretensioning the blades 601 using the tension ring 211 reduces inefficiencies due to tip gaps. In one embodiment, the tension ring 211 is made of metal such as aluminum or titanium or a composite such as carbon fiber. However, other materials may be used in other embodiments.

As shown in FIGS. 9A and 9B, the tension ring 211 includes a first end 903 and a second end 905. In one embodiment, the first end 903 has a diameter that is substantially the same as a diameter of the second end 905. The body 909 of the tension ring 211 is disposed between the first end 903 and the second end 905.

In one embodiment, the body 909 of the tension ring 211 includes a plurality of openings (e.g., slots) 907 that extend through the entire thickness of the tension ring 211. Each opening 907 is configured to connect to a first locking end 605 of one of the plurality of blades 601. Thus, there is a one-to-one relationship between each opening 907 of the tension ring 211 and the blades 601. In one embodiment, a fastener such as an epoxy is also applied to the first locking end 605 of each blade 601 to further strengthen the connection between the blades 601 and the tension ring 211.

In one embodiment, the plurality of openings 907 are formed at an angle with respect to a reference that is perpendicular to the first end 903 or second end 905. The angle in which the openings 907 is formed matches the pitch of the first locking ends 605 of the blades 601. The dimensions of the openings 907 substantially match the dimensions of the first locking ends 605 such that the first locking ends 605 are locked to the tension ring 211 once the first locking ends 605 are inserted into the openings 907 of the tension ring 211 and the first locking ends 605 are in direct contact with the tension ring 211.

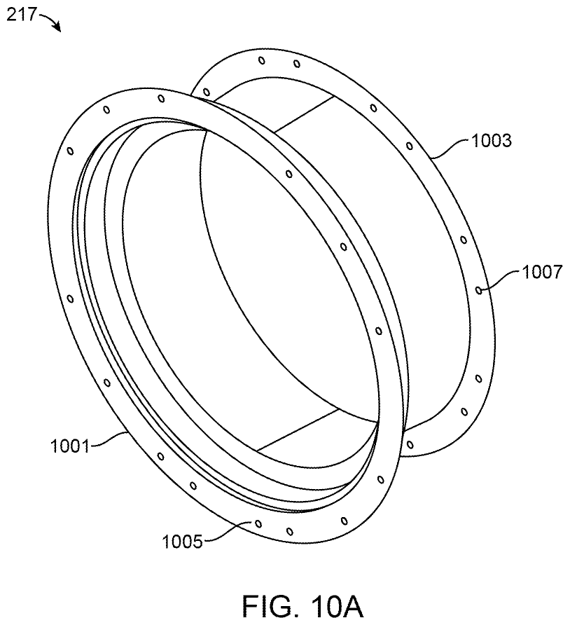

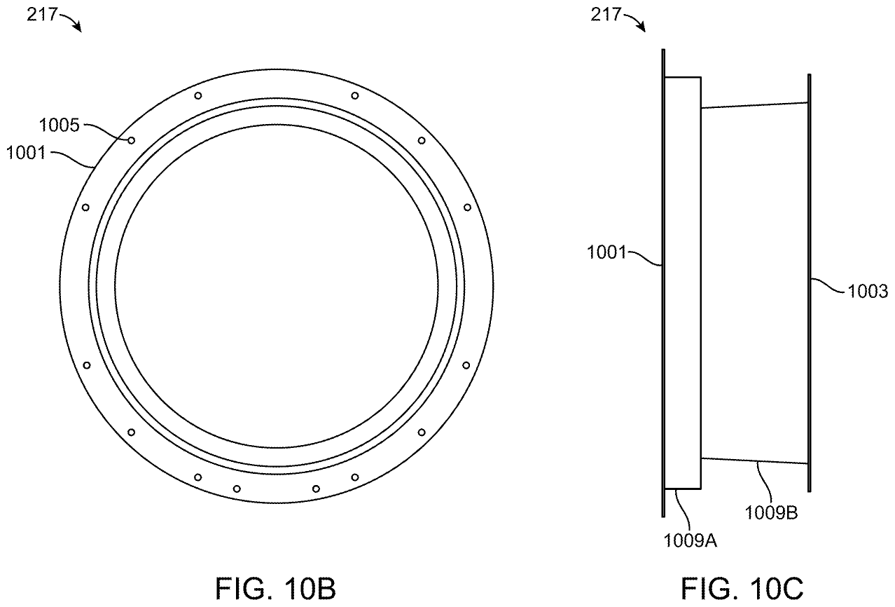

FIGS. 10A, 10B, and 10C respectively illustrate a perspective view, a front view, and a side view of an inner duct body housing 217 (hereinafter referred to a “body housing”) of the propulsor fan 100 according to one embodiment. In one embodiment, the body housing 217 is configured to house (e.g., partially surround) components of the propulsor fan 100. For example, the blade fan 209, hub 205, tension ring 211, locking ring 210, and motor 215 are housed within the body housing 217 in one embodiment. Other components of the propulsor fan 100 may be contained within the body housing 217 in other embodiments. In one embodiment, the body housing 217 is made of metal such as aluminum or titanium or a composite such as carbon fiber. However, other materials may be used in different embodiments.

In one embodiment, the body housing 217 is cylindrical in shape and includes a first end 1001 (e.g., an inlet) and a second end 1003 (e.g., an outlet). The first end 1001 has a diameter that is greater than a diameter of the second end 1003 in one embodiment. The first end 1001 includes a plurality of mounting holes 1005 that are formed around the circumference of the first end 1001 of the body housing 217. In one embodiment, the first end 1001 of the body housing 217 is configured to connect to the second end 305 of the duct lip 201 such that the mounting holes 223 in the duct lip 201 are aligned with the mounting holes 1005 of the body housing 217. As previously mentioned above, fasteners 207 may be used to secure the duct lip 201 to the first end 1001 of the duct body housing 217.

In one embodiment, the second end 1003 of the body housing 217 includes a plurality of mounting holes 1007 that are formed around the circumference of the second end 1003 of the body housing 217. In one embodiment, the second end 1003 of the body housing 217 is configured to connect to a first end (e.g., an inlet) the stator 219. While the second end 1003 of the body housing 217 is connected to the first end of the stator 219, the mounting holes 1007 in the second end 1003 of the body housing 217 are aligned with mounting holes on the first end of the stator 219. Fasteners (e.g., nuts, bolts, rivets) may be used to secure the second end 1003 of the body housing 217 to the first end of the stator 219.

In one embodiment, the body housing 217 includes a plurality of intermediate portions 1009 that are each configured to house different components of the propulsor fan. The plurality of intermediate portions 1009 include a first intermediate portion 1009A that extends from the first end 1001 and a second intermediate portion 1009B that extends from the second end 1003. The intermediate portions 1009 of the body housing 217 are disposed between the first and second ends 1001, 1003 of the body housing 217.

As shown in FIG. 10C, the first intermediate portion 1009A has a diameter that is different than a diameter of the second intermediate portion 1009B. For example, the diameter of the first intermediate portion 1000A is greater than the diameter of the second intermediate portion 1000B. Furthermore, the first intermediate portion 1009A has a diameter that is less than the first end 1001 and the second intermediate portion 1009B has a diameter that is less than the second end 1003.

In one embodiment, the first intermediate portion 1009A is configured to house the hub 205, the blade fan 209, the locking ring 210, and the tension ring 211. Since the tension ring 211 has the largest diameter of the components housed in the first intermediate portion 1009A, the diameter 1009A of the first intermediate portion 1009A is based on the diameter of the tension ring 211. In one embodiment, the diameter of the first intermediate portion 1009A is substantially the same as the diameter of the tension ring 211 thereby allowing the tension ring 211 to be securely fastened within the first intermediate portion 1000A due to a press fit, for example.

In one embodiment, the second intermediate portion 1009B is configured to house the motor 215 and a portion of the stator 219. The length of the second intermediate portion 1009B is based on a length of the motor 215 and a length of the portion of the stator 219 that are housed in the intermediate portion. The second intermediate portion 1000B has a length that is at least as long as the motor 215 and the portion of the stator 219 in order to contain the motor 215 and the portion of the stator 219 in the second intermediate portion 1009B. In one embodiment, the diameter of the second intermediate portion 1009B is based on the mass air flow of air entering and exiting the stator 219 Those skilled in the art will be able to tailor the diameter in order to induce favorable pressure gradients across a plurality of design speeds of interest to minimize flow separation or swirl. The inner cavity of the second portion 1009B may also be tuned to reduce noise.

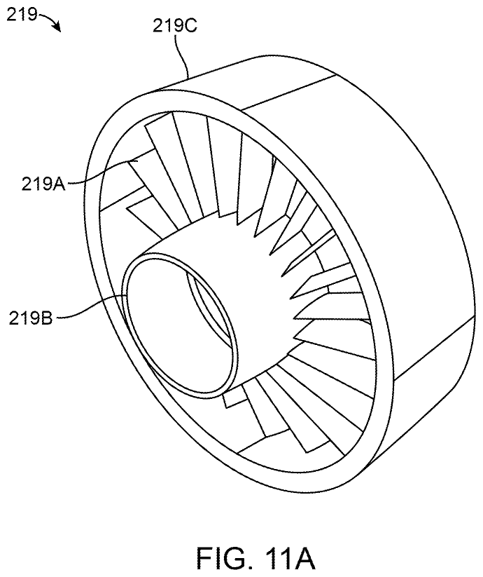

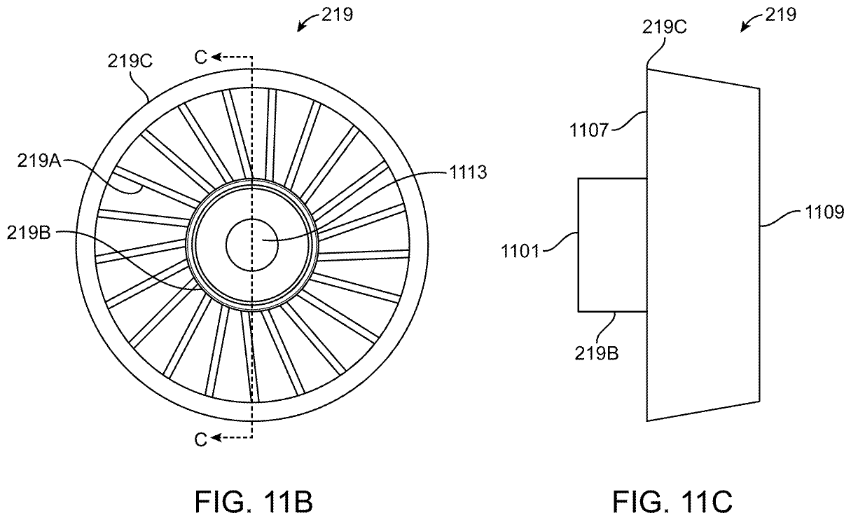

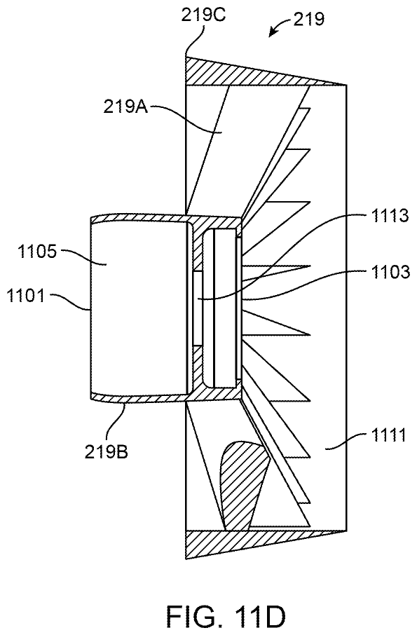

FIGS. 11A, 111B, 11C, and 11D respectively illustrate a perspective view, a front view, a side view, and a cross section view of a stator 219 of the propulsor fan 100 according to one embodiment. In one embodiment, the stator 219 comprises a plurality of stator blades 219A, a motor housing 219B, and a stator housing 219C. The stator 219 may include other components than those shown in FIGS. 11A to 11D in other embodiments.

In one embodiment, the motor housing 219B is cylindrical in shape and includes a first end 1101 and a second end 1103 as shown in FIG. 11D. FIG. 11D illustrates a cross-section view of the stator 219 along plane C-C′ in FIG. 11B according to one embodiment. As shown in FIG. 11D, the motor housing 219B includes a cavity 1105 disposed between the first end 1101 and the second end 1103. The cavity 1105 may extend from the first end 1101 towards the second end 1103, but does not extend to the second end 1103. In one embodiment, the cavity 1105 is configured to house the motor 215. That is, the motor 215 is placed within the cavity 1105 of the motor housing 219B. Thus, the shape and size of the cavity 1105 is dependent on the shape and size of the motor 215. Since the motor 215 is placed within the cavity 1105 and the motor 215 is indirectly connected to the hub 205, the stator 219 also functions as a structural component to support the hub 205 and other components of the propulsor 100.

In one embodiment, the motor housing 219B includes a hole 1113 through a center of the motor housing 219B as shown in FIGS. 11B and 11D. The diameter of the hole 1113 is less than a diameter of the motor 215 to prevent the motor 215 from falling through the hole 1113. The hole 1113 is placed in the motor housing 219B to aid in heat dissipation thus cooling the motor 215.

Referring to FIG. 11B, the stator 219 includes a plurality of stator blades 219. The stator blades 219A extend radially from the motor housing 219B. That is, the root of each blade 219A is connected to the motor housing 219B and the airfoil of the stator blade 219 extends outward away from the motor housing 219B. In one embodiment, each blade 219A extends away from the motor housing 219B at an angle measured with respect to a reference line that extends perpendicular from a point on the motor housing 219B from which the stator blade 219A extends.

In one embodiment, the stator blades 219 conduct heat away from the motor 215. Since the blades 219 contact the motor housing 219B which houses the motor 215, air that passes over the blades 219 dissipates heat generated by the motor 215. In one embodiment, the arrangement of the blades 219 also reduces noise generated by the blade fan 209 and controls thrust generated by the propulsor fan 100. The blade count of the stator blades 219 can be selected so that the harmonics of the stator cancel out harmonics of the blade fan 209. For ultrasonic fans, because of the localized low Reynolds number along the blade, those skilled in the art will see that the blade fan 209 may carry a plurality of blades 601 that is higher in count (e.g., total amount) than the stator blades 219 for favorable acoustics. This may vary anywhere from 50% to 200% more blades for a particular set of design tones.

In one embodiment, the stator housing 219C is configured to house the stator blades 219 and the motor housing 219B. That is, the stator blades 219 are placed within the stator housing 219C such that the stator housing 219C surrounds the circumference of the blades 219. In one embodiment, the stator housing 219C includes a first end 1107 (e.g., an inlet) and a second end 1109 (e.g., an outlet). As shown in FIG. 11C, the first end 1107 has a diameter that is greater than a diameter of the second end 1109. Thus, the stator housing 219C may have a conical shape. However, the stator housing 219C may have other shapes in other embodiments.

Referring to FIG. 11D, in one embodiment the tips of the blades 219A are in contact with an inner surface 1111 of the stator housing 219C. Thus, the blades 219A of the stator are stationary. By contacting the blades 219A with the inner surface 1111 of the stator housing 219C, the position of each blade 219A is static.

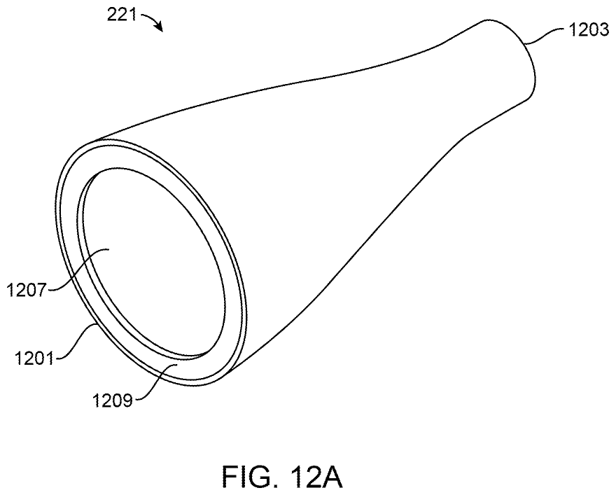

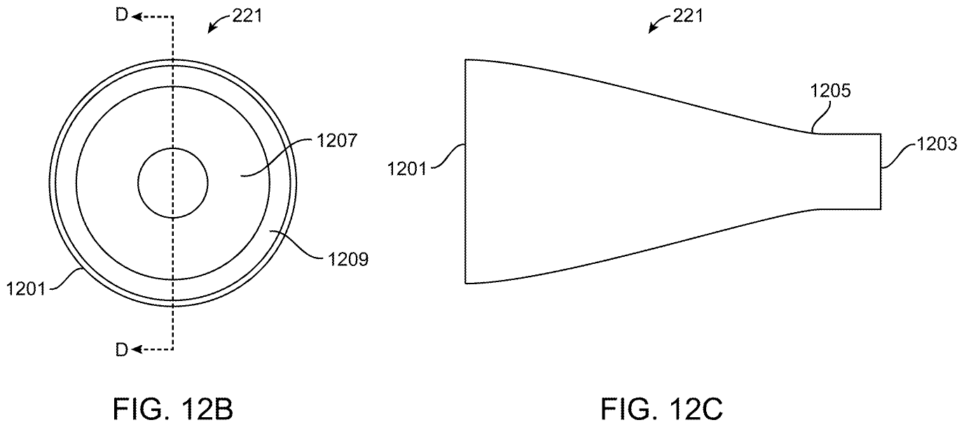

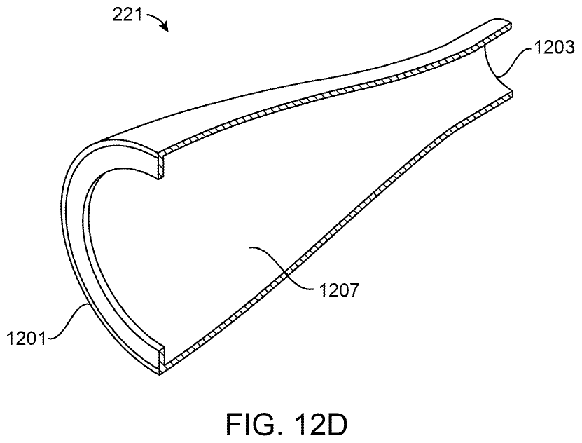

FIGS. 12A, 12B, 12C, and 12D respectively illustrate a perspective view, a front view, a side view, and a cross section view of a tail cone 221 of the propulsor fan 100 according to one embodiment. The tail cone 221 is configured to produce the correct change of area of the stator housing 219C through with the air exits the propulsor fan 100 in one embodiment. The tail cone 221 may be made of metal such as aluminum or titanium or may be made of a composite such as carbon fiber.

The tail cone 221 includes a first end 1201 (e.g., an inlet) and a second end 1203 (e.g., an outlet). In one embodiment, the first end 1201 comprises a diameter that is greater than a diameter of the second end 1203. In one embodiment, the diameter of the tail cone 221 is different across a length of the tail cone 221. As shown in FIG. 12C, the diameter of the tail cone 221 reduces from the first end 1201 towards the second end 1203 until an intermediate point 1205 is reached. From the intermediate point 1205 to the second end 1203, the diameter of the tail cone 221 is relatively constant.

In one embodiment, the first end 1201 of the tail cone 221 is configured to connect to the second end 1103 of the motor housing 219B of the stator 219. Thus, the diameter of the second end 1201 of the tail cone 221 substantially matches a diameter of the second end 1103 of the motor housing 219B of the stator 219. In one embodiment, the first end 1201 of the tail cone 221 includes a mounting surface 1209 that mates with (e.g., contacts) the second end 1103 of the motor housing 219B. The mounting surface 1209 may be attached to the motor housing 219B using fasteners for example. However, other attachment mechanisms may be used in other embodiments.

Referring to FIG. 12D, a cross-section view of the tail cone 221 along plane D-D′ shown in FIG. 12B is shown. In one embodiment, the tail cone 221 includes a cavity 1207 formed through the length of the tail cone 221 starting from the first end 1201 of the tail cone to the second end 1203 of the tail cone. Shaping of the aft end of the tail cone 221 is governed by exhausted secondary flow from the interior of the tail cone 221 with respect to the expansion of the jet following the blade disk and/or stator.

In one embodiment, the propulsor fan 100 includes a center hub driven motor 215. That is, a single motor 215 is used to drive the propulsor fan 100 in one embodiment. An example motor used for the propulsor fan 100 is an electric motor. However, other types of motors such as a gas motor or jet turbine may be used in the propulsor fan 100 in other embodiments. Generally, different motor types and sizes may be used depending on the application of the propulsor fan 100.

### Multi-Motor Drive System

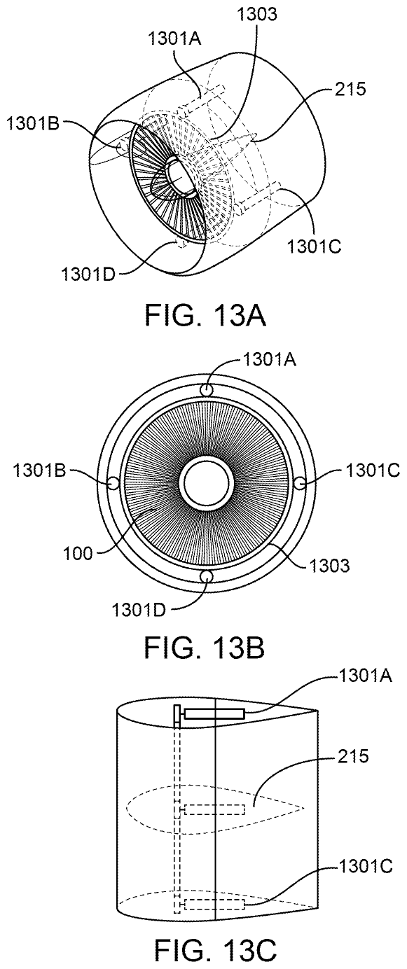

In another embodiment, the propulsor fan 100 may be driven by a plurality of motors rather than just a single motor 215 described above. FIGS. 13A, 13B, and 13C respectively illustrate a perspective view, a front view, and a side view of a circumferential multi-motor drive system of the propulsor fan 100 according to one embodiment.

Instead of driving thrust with a single motor 215, a plurality of auxiliary motors 1301A, 1301B, 1301C, and 1301D are placed within the body housing 217 to drive the blade fan 209 via a ring gear 1303. The plurality of auxiliary motors 1303 may be electric motors in one embodiment. However, other types of motors may be used.

The ring gear 1303 may be connected to the tension ring 211 in one embodiment. The auxiliary motors 1303 may replace the motor 215 described above or may be used in conjunction with the motor 215. Multi-motor redundancy allows for exceptional fault tolerance of the propulsor fan 100 system. With four auxiliary motors 1303 for example, the loss of a single auxiliary motor is nearly inconsequential to the propulsor's normal operation. Even with the loss of another motor, the remaining auxiliary motors 1303 may be overspeed to generate sufficient thrust.

As shown in FIGS. 13A to 13C, the auxiliary motors 1301A to 1301D are spread radially around the circumference of the propulsor 100 instead of all being located at the hub 205 of the propulsor. The end of each auxiliary motor 1301 includes a gear that is connected to the ring gear 1303. The radial arrangement need not be limited to equal angular spacing. For example, the fan may be driven by three motors which are biased toward the lower quadrant of the duct. Furthermore, rather than requiring the stator 219 to support the hub 205 to support the centrally housed motor 215, the propulsor can leverage the duct structure itself to handle the motor and its load. In addition to removing weight and drag, this also results in less broadband noise typically caused by stator flow interaction. In one embodiment, the auxiliary motors 1303 operate more at a high 20,000 RPM where they can generate a superior 15 kW/kg specific power compared to heavier, lower speed motors at a 5 kW/kg specific power. The auxiliary motors 1303 drive the ring gear 1303 in unison to eliminate gear slippage (axial and radial directions). This low bearing results in lower gear noise.

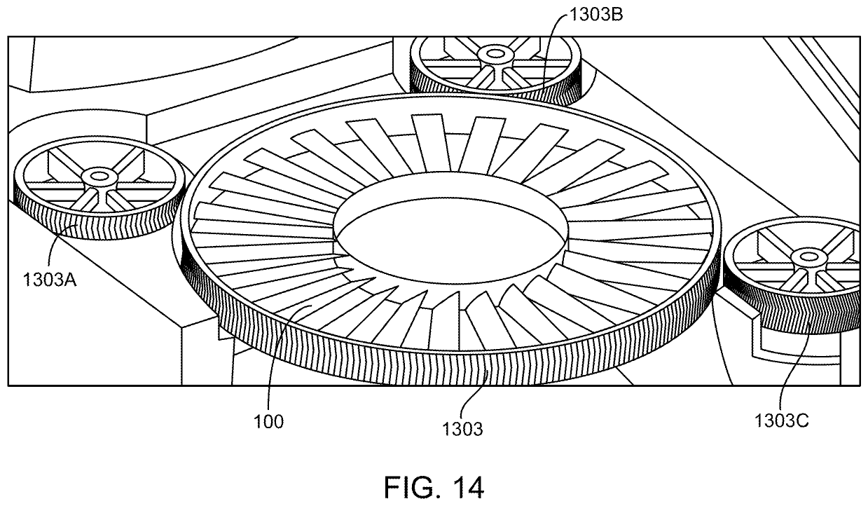

FIG. 14 illustrates yet another embodiment of the circumferential drive system of the propulsor fan 100 according to another embodiment. The embodiment shown in FIG. 14 is similar to the example described in FIG. 13. However, the drive system shown in FIG. 14 omits the centrally driven motor 215 and relies upon the auxiliary motors 1303 for thrust generation.

### Propulsor Array

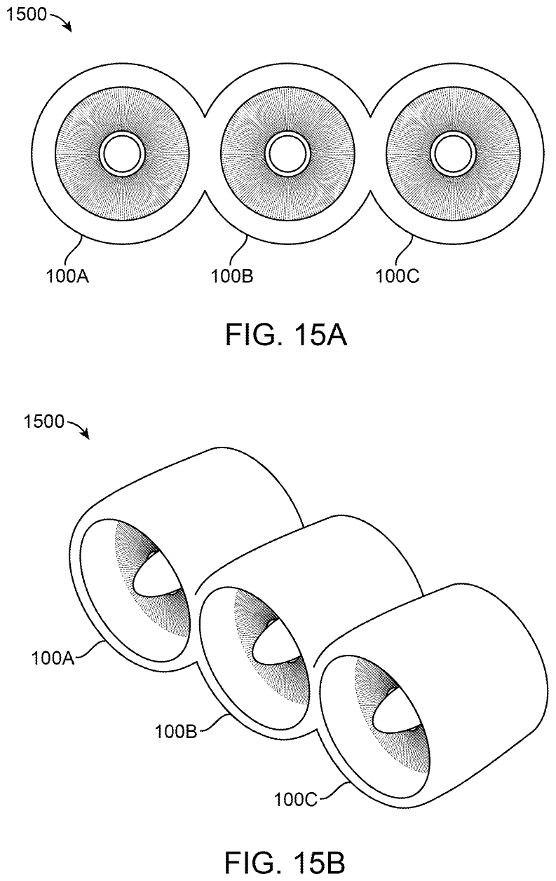

FIGS. 15A and 15B respectively illustrate a front view and a perspective view of an array of propulsor fans 1500 according to one embodiment. In one embodiment, the array of propulsor fans 1500 includes a plurality of propulsor fans 100 that are laterally arranged to form a row of propulsor fans. In the example shown in FIGS. 15A and 15B, the array of propulsor fans 1500 include a first propulsor fan 100A, a second propulsor fan 100B, and a third propulsor fan 100C. Each of the plurality of propulsor fans 100A to 100C includes the propulsor fan structure described herein. While three propulsor fans 100 are included in the array of propulsor fans 1500, the array may include any number of propulsor fans greater than two.

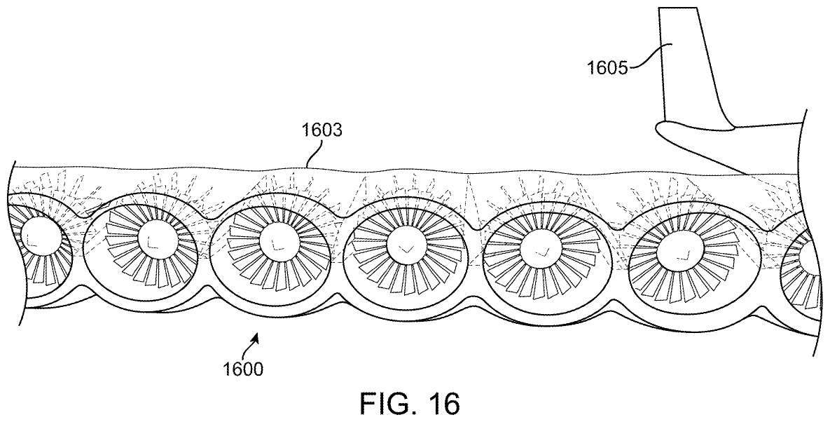

FIG. 16 illustrates an example application of an array of propulsor fans 1600 according to one embodiment. As shown in FIG. 16, the array of propulsor fans 1600 includes a plurality of propulsor fans as described herein. The array of propulsor fans 1600 is integrated into a duct wing 1603 of an aircraft 1605 in one embodiment. Multiple propulsor fans can be combined laterally to form a duct wing 1603. The duct wing 1603 can be shaped to create a passive lifting biplane where biplane stagger, sweep, taper, and dihedral can be added as needed. The total number of propulsor fans and size of the propulsor fans to include in the array 1600 is dependent on the requirements of the aircraft such as the number of passengers that will be on the aircraft, speed requirements, and altitude requirements of the aircraft 1605 for example.

The combination of the propulsor fans into an array opens up several control and thrust vectoring opportunities. Thrust can simply be varied between each individual propulsor fan 100 to induce yawing, rolling, or pitching moments. Relative spanwise pitch differences between the propulsor fans can be used to catalyze faster climbs and descents. This can be further augmented with additional control surfaces installed at the trailing edge.

The spanwise combination of ducts lend themselves well to integration along the wing or even as a biplane wing itself. The array can be arranged and extended as a biplanar wing with sweep, stagger, dihedral and taper to fit system needs. The choice to integrate the array of propulsor fans as a full biplanar wing is dependent on the amount of thrust (minus drag) required as well as the relative size of the propulsor fan.

### Propulsor Fan Applications

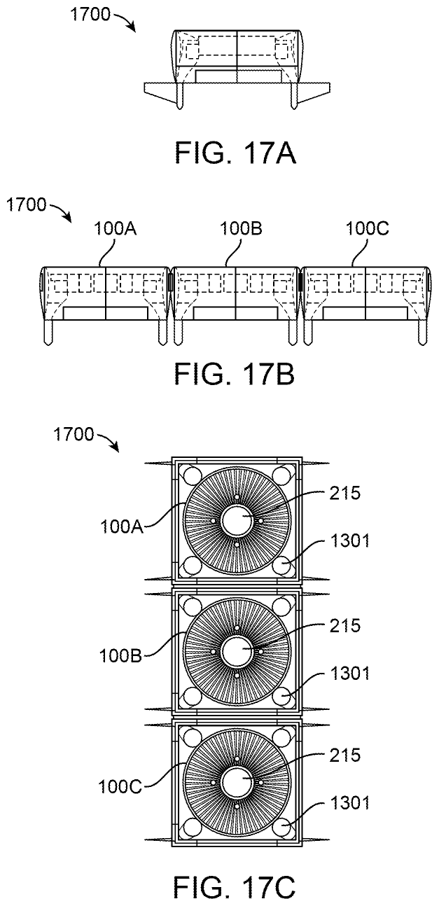

FIGS. 17A, 17B, and 17C respectively illustrate a front view, a side view, and a top view of a hover drone 1700 according to one embodiment. The hover drone 1700 includes an array of propulsor fans including a first propulsor fan 100A, a second propulsor fan 100B, and a third propulsor fan 100C. Although only three propulsor fans are included in the hover drone 1700, the hover drone 1700 can include additional propulsor fans or less propulsor fans than shown in FIGS. 17A to 17C.

The hover drone 1700 is a quiet, electric vertical takeoff and landing (VTOL) drone that includes an array of propulsor fans as described herein. The hover drone 1700 may be used for close quarters such as in urban settings. The hover drone 1700 may have 360 degree cameras and sensors and may be used for hover flight times greater than 15 minutes, for example. In one example, the propulsor fans 100A to 100C may each have a 1 ft diameter with an augmented disc loading of 6.4 lb/ft². The hover drone 1700 may have a maximum takeoff weight of 30 pounds.

In the example shown in FIG. 17A, each propulsor fan 100A to 100C includes a hub driven centrally located motor 215 as well as auxiliary motors 1301 as previously described above. However, the hover drone 1700 may omit the auxiliary motors 1301 and include only the centrally located motor 215 or may omit the centrally located motor 215 and include only the auxiliary motors 1301.

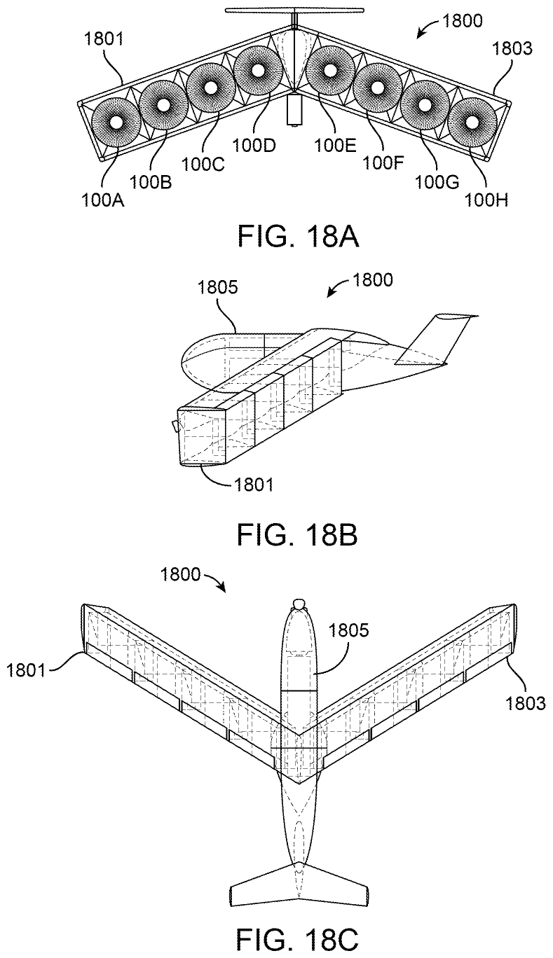

FIGS. 18A, 18B, and 18C respectively illustrate a front view, a side view, and a top view of a cinema drone 1800 including an array of propulsor fans according to one embodiment. Generally, the cinema drone 1800 is a quiet deflected slipstream VTOL drone used for cinema needs. The cinema drone 1800 may be all electric or hybrid. The cinema drone 1800 may have a Gimbaled payload (e.g., a main camera) up to 35 pounds for example. The cinema drone 1800 may have secondary cameras and sensors. The cinema drone 1800 may be used for hover flight times greater than 20 minutes. The cinema drone may have a maximum cruise speed of greater than 50 mph in one embodiment.

In one embodiment, the cinema drone 1800 is a biplane and has a neutral stagger. As shown in FIGS. 18A, the cinema drone 1800 includes a first wing 1801 and a second wing 1803. Each of the first wing 1801 and the second wing 1803 includes an array of propulsor fans that includes a plurality of propulsor fans. For example, the array of propulsor fans included in wing 1801 includes propulsor fans 100A, 100B, 100C, and 100D whereas the array of propulsor fans included in wing 1803 includes propulsor fans 100E, 100F, 100G, and 100H. Thus, half of the propulsor fans are at a first side of the fuselage 1805 and the remaining half of the propulsor fans are at a second side of the fuselage 1805. In the example shown in FIGS. 18A to 18C, the array of propulsors includes eight propulsors, but any number of propulsors may be used.

Each wing 1801, 1803 of the cinema drone 1800 shown in FIGS. 18A to 18C has angular sweep formed between the two wings towards the front of the fuselage 1805. In the example shown in FIGS. 18 to 18C, wings 1801 and 1803 may have a wing anhedral of 20 degrees and a wing sweep of 30 degrees. However, other angles may be used in different embodiments.

In one embodiment, the cinema drone 1800 shown in FIGS. 18A to 18C has a maximum takeoff weight of 75 pounds and a target max payload weight of 30 pounds in one example. Each propulsor fan 100 may have a fan diameter of 1 ft with an augmented disc loading of 6.0 lb/ft² for example. The fuselage 1805 of the cinema drone 1800 may have a length of 5.5 ft and a width of 0.6 ft. The wingspan of the cinema drone 1800 may be 8.8 ft with a wing area of 17.4 ft² with a wing loading of 4.3 lb/ft² for example.

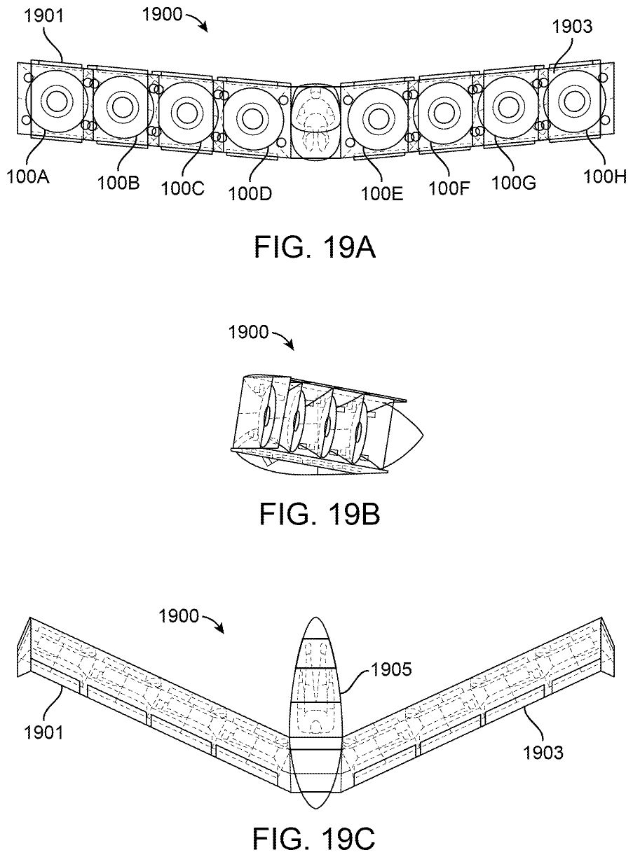

FIGS. 19A, 19B, and 19C respectively illustrate a front view, a side view, and a top view of a transporter aircraft 1900 including an array of propulsor fans according to one embodiment. The transporter aircraft 1900 is an optionally-manned VTOL plane. The transporter aircraft 1900 may be hybrid or full electric. The transporter aircraft 1900 may have a range of 20-60 nautical miles with a cruising speed of 130 to 250 knots at an operating altitude of 1,000 to 2,000 feet, for example.

In one embodiment, the transporter aircraft 1900 is a biplane and has a slight negative stagger. The transporter aircraft 1900 includes a first wing 1901 and a second wing 1903. An angle is formed between the two wings 1901 and 1903 towards the front of the fuselage 1905. In the example shown in FIGS. 19A to 19C, the wings may have a wing dihedral of 5 degrees and a wing sweep of −25 degrees. However, other angles may be used in different embodiments.

In one embodiment, an array of propulsor fans are integrated into each wing 1901 and 1903. A first array of propulsor fans is at a first side of the fuselage 1905 and is integrated into wing 1901 and a second array of propulsor fans is at a second side of the fuselage 1905 and is integrated into wing 1903. For example, the array of propulsor fans included in wing 1901 includes propulsor fans 100A, 100B, 100C, and 100D whereas the array of propulsor fans included in wing 1903 includes propulsor fans 100E, 100F, 100G, and 100H. Thus, half of the propulsor fans are at a first side of the fuselage 1905 and the remaining half of the propulsor fans are at a second side of the fuselage 1905. In the example shown in FIGS. 19A to 19C, the arrays of propulsors includes eight propulsor fans, but any number of propulsor fans may be used.

In one embodiment, the transporter aircraft 1900 has a maximum takeoff weight of 1,000 pounds and a target max payload weight of 220 pounds in one example. Each propulsor fan 100 may have a fan diameter of 3 ft with an augmented disc loading of 6.0 lb/ft². The fuselage 1905 of the transporter plane 1900 may have a length of 9.2 ft and a width of 3.75 ft. The wingspan of the transporter aircraft 1900 may be 28.7 ft with a wing area of 106.3 ft² with a wing loading of 9.4 lb/ft².

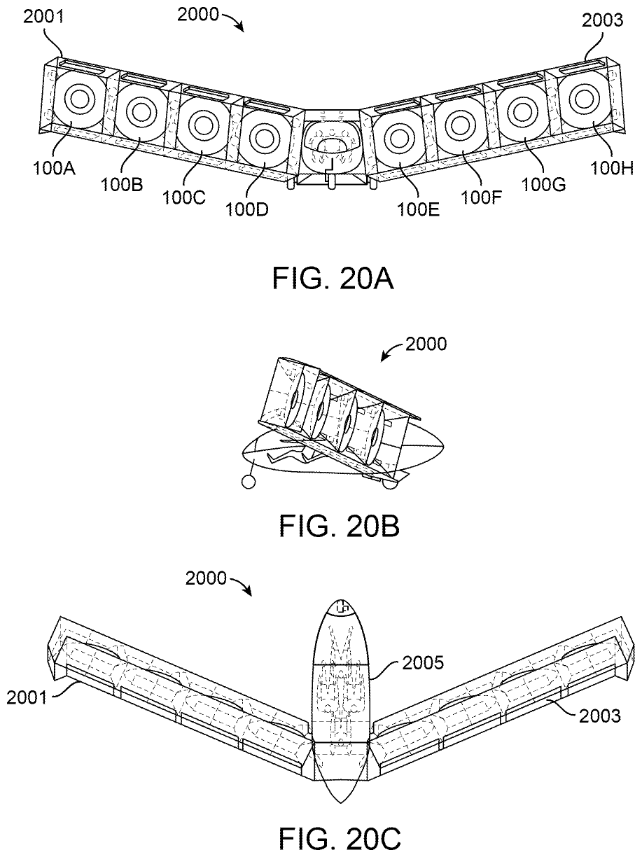

FIGS. 20A, 20B, and 20C respectively illustrate a front view, a side view, and a top view of a vertical takeoff and landing (VTOL) aircraft 2000 including an array of propulsor fans according to one embodiment. The VTOL aircraft 2000 is an optionally-manned VTOL plane. The VTOL aircraft 2000 may be hybrid or full electric. The VTOL aircraft 2000 may have a range of 20-400 nautical miles with a cruising speed of 130 to 250 knots at an operating altitude of 1,000 to 2,000 feet. In one embodiment, the VTOL aircraft 2000 is capable of hovering.

In the example shown in FIGS. 20A to 20C, the VTOL aircraft 2000 is a biplane and has a slight negative stagger. The VTOL aircraft 2000 includes a first wing 2001 and a second wing 2003. In one embodiment, an angle is formed between the two wings 2001, 2003 towards the front of the fuselage 2005. The wings 2001, 2003 may have a wing dihedral of 5 degrees and a wing sweep of −25 degrees. However, other angles may be used in different embodiments.

In one embodiment, an array of propulsor fans are integrated into each wing 2001 and 2003. A first array of propulsor fans is at a first side of the fuselage 2005 and is integrated into wing 2001 and a second array of propulsor fans is at a second side of the fuselage 2005 and is integrated into wing 2003. For example, the array of propulsor fans included in wing 2001 includes propulsor fans 100A, 100B, 100C, and 100D whereas the array of propulsor fans included in wing 2003 includes propulsor fans 100E, 100F, 100G, and 100H. Thus, half of the propulsor fans are at a first side of the fuselage 2005 and the remaining half of the propulsor fans are at a second side of the fuselage 2005. In the example shown in FIGS. 20A to 20C, the arrays of propulsors includes eight propulsor fans, but any number of propulsor fans may be used.

The VTOL aircraft 2000 has a maximum takeoff weight of 5,000 pounds and a target max payload weight of 1,000 pounds (e.g., 3-4 passengers) in one example. Each propulsor fan 100 may have a fan diameter of 5 ft with an augmented disc loading of 11.0 lb/ft². The fuselage 2005 of the VTOL aircraft 2000 may have a length of 24.7 ft and a width of 5 ft, for example. The wingspan of the VTOL aircraft 2000 may be 49 ft with a wing area of 300 ft² with a wing loading of 16.7 lb/ft² for example.

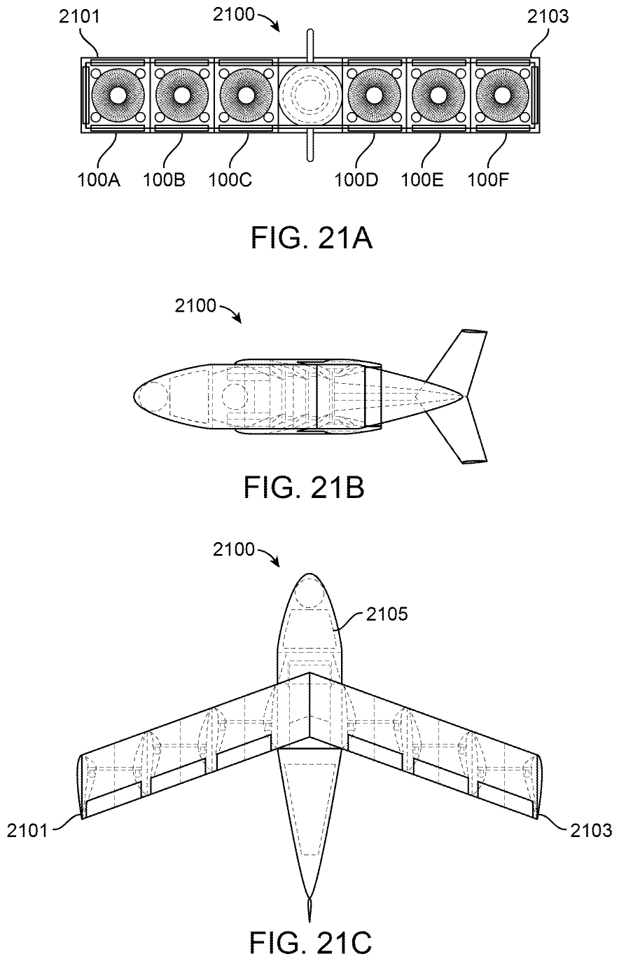

FIGS. 21A, 21B, and 21C respectively illustrate a front view, a side view, and a top view of a delivery drone 2100 including an array of propulsor fans according to one embodiment. The delivery drone 2100 may have 360 degree cameras and sensors and may be used for hover flight times greater than 20 minutes. The delivery drone 2100 may have a maximum cruise speed of greater than 50 mph in one embodiment.

The delivery drone 2100 is an example of an electric tail sitter VTOL drone configured to deliver an internal package. In the example shown, the delivery drone 2100 is a biplane and has a neutral stagger. The delivery drone 2100 includes a first wing 2101 and a second wing 2103 with angular sweep formed between the two wings towards the rear of the fuselage 2105 in one embodiment.

In one embodiment, an array of propulsor fans are integrated into each wing 2101 and 2103. A first array of propulsor fans is at a first side of the fuselage 2105 and is integrated into wing 2101 and a second array of propulsor fans is at a second side of the fuselage 2105 and is integrated into wing 2103. For example, the array of propulsor fans included in wing 2101 includes propulsor fans 100A, 100B, and 100C whereas the array of propulsor fans included in wing 2103 includes propulsor fans 100D, 100E, and 100F. Thus, half of the propulsor fans are at a first side of the fuselage 2105 and the remaining half of the propulsor fans are at a second side of the fuselage 2105. In the example shown in FIGS. 21A to 21C, the arrays of propulsors includes six propulsor fans, but any number of propulsor fans may be used.

The delivery drone 2100 has a maximum takeoff weight of 55 pounds and a target max payload weight of 5.5 pounds in one example. Each propulsor fan 100 may have a fan diameter of 1 ft with an augmented disc loading of 6.0 lb/ft². The fuselage 2105 of the delivery drone 2100 may have a length of 6.7 ft and a width of 1.3 ft. The wingspan of the delivery drone 2100 may be 8.8 ft with a wing area of 21.9 ft² with a wing loading of 2.5 lb/ft² for example.

### Free Blade

Since the propulsor fan 100 described herein has higher speed capability above 150 mph, there is a desire to provide increased propulsive efficiency through either blade angle variability or mass flow throttling. As described above, the propulsor fan 100 includes significantly higher blade count than conventional propulsors. Implementing a typical variable pitch propeller mechanism would be overly burdensome from a mechanical complexity perspective.

In one embodiment, an array of the propulsor fans as described above is incorporated into an aircraft using a free wing blade structure. The free wing blade structure may be implemented in any of the aircraft described above in FIGS. 17 to 21, for example. Free-wing blades are propulsor fans which are able to rotate freely along their radial axis due to mass balancing ahead of each blade's aerodynamic center. That is, the blade fan 209 is able to rotate freely along their radial axis due to mass balancing ahead of each blade's aerodynamic center. Free-wing blades combine airfoil design, wing mass balancing, and a wing pivot to achieve a capability where a wing is free to pivot as it self-trims to a zero pitching moment at a constant CL across all flight conditions.

The combination of the free blade structure with the propulsor fan 100 creates a passive system for blade angle of attack (AoA) variability while maintaining a constant blade loading. This could provide a unique synergy to electric motor driven propulsor fans 100 since electric motors can operate at a high efficiency across a broad range of rpm. The electric motors could operate at higher or lower radial velocities across different inflow velocities, with the blades ‘floating’ to align their AoA to maintain the same trimmed coefficient of lift (CL). This capability may also provide value to achieve lower noise, as a method of avoiding blade stall, which results in high noise at different flight conditions and turbulence levels.

The usage of free blades results in a number of benefits. For example, free blades are pitch balanced to always be at an AoA near their L/Dmax CL (typically 0.5 to 1.0) through the addition of leading edge blade mass. This ensures the blade AoA is always matched to align with the inflow and there's never separated flow. Furthermore, mass balancing is possible with the propulsor fan 100 when the inner hub area is empty since it is rim driven, providing volume ahead of the blade for the lightest mass balancing counterweights (and without being exposed to the flow). This permits the propulsor fan 100 to vary its rpm on the order of ˜50% during different flight segments to enable blades to always be near their optimum advance ratio. Use of free blades in combination with an electric motor offers particular benefit because unlike turbines or IC engines, electric motors have a broad rpm of high efficiency. Therefore turbines or IC engines need to operate at a fixed rpm for a given power, while electric motors do not. This permits the propulsor to vary it's rpm on the order of ˜50% during different flight segments to enable blades to always be near their optimum advance ratio. Lastly, free blades may also be helpful in enabling larger scale VTOL integrations due to wider AoA variations and thrust needs.

### Circulation Duct Control

In one embodiment, a circulation control mechanism is placed at the duct lip 201. The circulation control mechanism is configured to blow a jet of air at the duct lip 201. By applying air to the duct lip 201, the amount of lip suction that the duct lip 201 is able to achieve is augmented. In one embodiment, electric motors in combination with centrifugal or axial compressors would be embedded in the remaining duct volume to increase circulation control blowing and/or suction at the duct lip 201. By applying distributed electric propulsion (DEP) for internal circulation control blowing at the duct lip 201, static and low speed thrust augmentation can be achieved with a lower power than putting additional power into the propulsor. This internal application of DEP maximizes aero integration benefits, both at the propulsor fan 100 and aircraft integration levels. Applying circulation control at the duct lip 201 results in up to a 40% increase in static thrust at the same fan power, for example.

In one embodiment, an emergency power ram air turbine with a high PR and intake velocities that required high circulation control jet blowing velocities (i.e., nearly sonic noisy jets). Quiet low velocity jets (˜300 ft/sec) may be used and could be powered by small internal duct electrical centrifugal blowers.

A lower velocity circulation control jet could be equally impactful in terms of thrust augmentation for the propulsor considering the much lower PR and static duct inflow velocities. Circulation control effectiveness is a function of Vjet/Vintake. Another intriguing aspect of circulation control duct lip blowing is the avoidance of duct inner lip separation at high angles of attack (i.e., during transition). This is an important consideration for ducted eVTOL—if the inlet air flow separates at the duct lip, a considerable increase in noise results as the fan blades experience oscillating flow conditions that result in cyclic blade loading.

Through application of circulation control blowing at the duct lip 201 with jet speeds of about 300 ft/sec, the duct lip suction force can be increased to account for ˜75% of the total static thrust. Blowing air at the duct lip 201 effectively provides aerodynamic shape morphing on the duct lip to entrain additional ambient air. With the blowing turned on, the inflow air ‘sees’ a far larger bell mouth duct lip which is desired at static conditions. Having an actual bell mouth duct inlet would cause significant drag at cruise. The duct circulation control blowing can be turned off during cruise flight when the blowing is relatively ineffective. A compact high speed centrifugal blower operates at ultrasonic blade passage frequencies to provide internal blowing. While circulation control blowing is most effective at high nozzle jet speeds (near sonic is best), our nozzle jet has been designed for lower jet speeds to achieve low noise (jet noise varies to the 10th power of the nozzle speed). With this application to the duct leading edge the goal is maximizing the inflow turning angle and preventing leading edge duct lip stall.

In one embodiment, the circulation control duct may be applied to the duct lip 201 in any of the aircraft embodiments discussed herein.

Blade Fan with Pin Root Attachment, Tip Shroud, and Knife Edge Seals

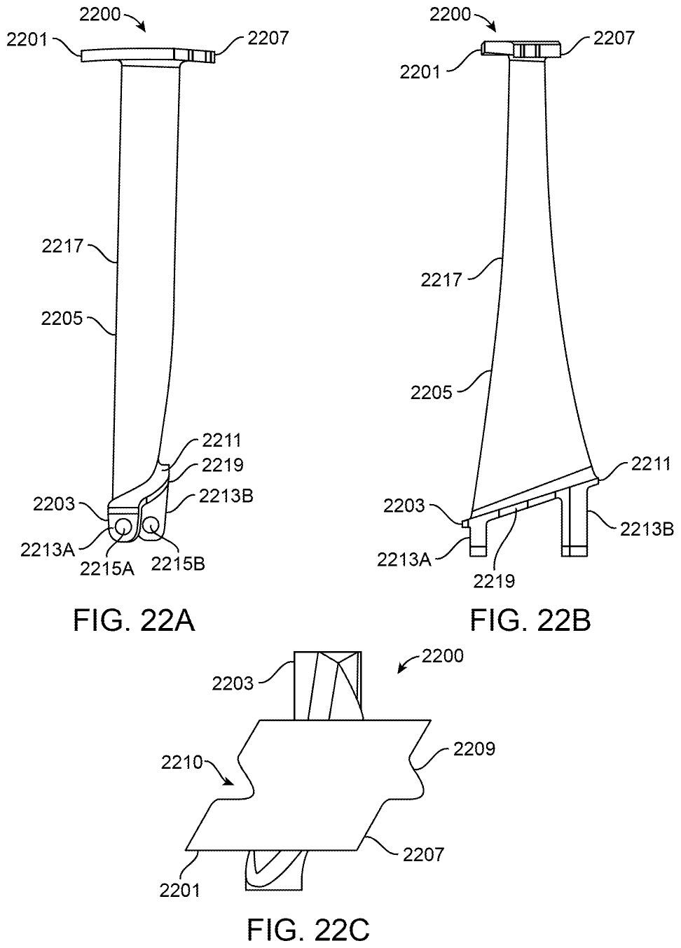

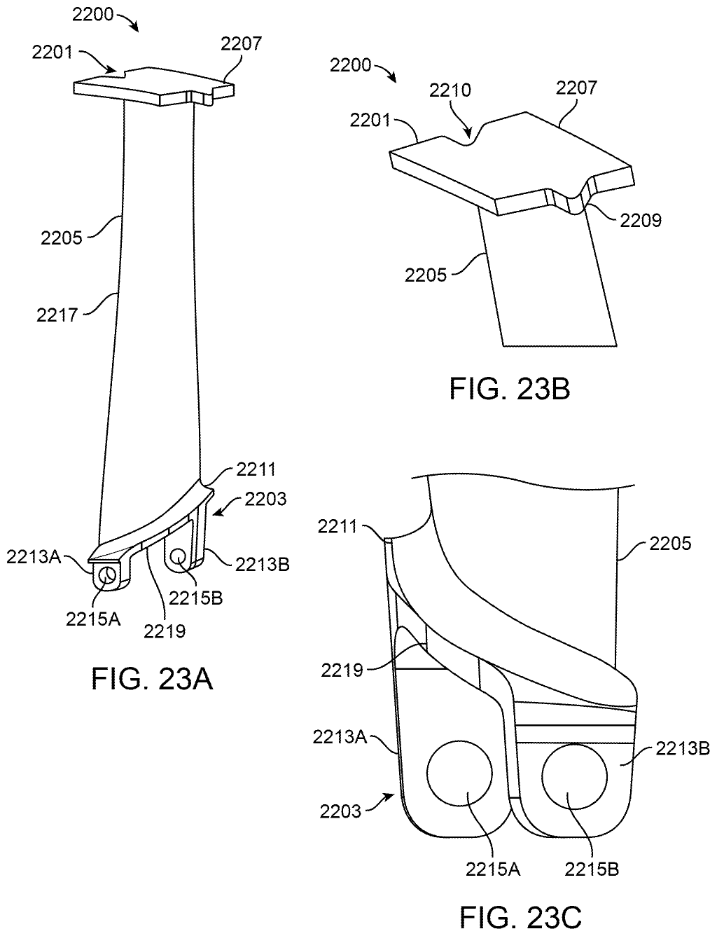

In one embodiment, a blade fan for use in the propulsor fan 100 described above includes blades with a pin root to attach the blades to a hub rather than the locking end previously described above with respect to FIGS. 7A, 7B, and 7C. FIGS. 22A, 22B, and 22C respectively illustrate a front view, a side view, and a top view of a blade 2200 having a dual pin hole root according to a second embodiment. FIGS. 23A, 23B, and 23C respectively illustrate a perspective view of the blade 2200 with the dual pin-root, a perspective view of a shroud segment 2207 of the blade 2200, and a perspective view of the dual pin-root of the blade 2200 according to the second embodiment.

In one embodiment, each blade 2200 comprises a first end 2201, a second end 2203 that is at an opposite location from the first end 2201, and an airfoil 2205 between the first end 2201 and the second locking end 2203 of the blade 2200. The blade 2200 may include other features than those described herein in other embodiments. The first end 2201 is located at the tip of the blade 2200.

In one embodiment, the first end 2201 of each blade 2200 includes a shroud segment (e.g., a shroud portion) 2207. Each shroud segment 2207 of a blade 2200 is configured to be connected to a plurality of other shroud segments 2207 of other blades 2200 included in the blade fan. The shroud segments 2207 interlock with each other to collectively form an inter-locking tip shroud. The tip shroud is disposed along the circumference of the blade fan as will be described in further detail below.

By interlocking the first ends 2201 (e.g., the tips) of the blades 2200 using the shroud segments 2207, the first ends 2201 of the blades 2200 are tensioned such that a pitch of the first ends 2201 of the blades 2200 during thrust generation is substantially the same as a pitch of the first ends 2201 of the blades 2200 at rest hereby reducing noise that may result from changes in the angle of the blades 2200. Thus, the blades 2200 do not require a locking ring 211 to tension the tips of the blades 2200 as described in the embodiment of FIG. 7 due to the interlocking shroud segments 2207.

In one embodiment, each shroud segment 2207 is integrated in the blade 2200 that includes the shroud segment 2207. The shroud segment 2207 may extend from the end of the airfoil 2205 of the blade 2200 that is farthest from the second end 2203 of the blade 2200. The shroud segment 2207 has a width that is wider than a width of the end of the airfoil 2205. In one embodiment, the shroud segment 2207 is quadrilateral in shape (e.g., a parallelogram, rectangle, or square) in the top view of the shroud segment 2207 shown in FIG. 22C. The shroud segment 2207 also has a curvature in an upper surface and a lower surface of the shroud segment 2207 as shown in FIGS. 22A and 22B. The shroud segments 2207 are curved in order to form a circular tip shroud around a circumference of the blade fan while the shroud segments 2207 of the blades 2200 are interlocked together.

In one embodiment, each shroud segment 2207 includes connection mechanisms to connect the shroud segment 2207 of a blade 2200 to another shroud segment 2207 of another blade 2200. In one embodiment, the connection mechanisms include a protrusion 2209 at a first side of the shroud segment 2207 and a recess 2210 at a second side of the shroud segment 2207 that is opposite the first side of the shroud segment 2207. In one embodiment, the second side is parallel to the first side of the shroud segment 2207. The remaining sides of the shroud segment 2209 lack the protrusion 2209 and the recess 2210.

Generally, the protrusion 2209 of a given shroud segment 2207 is configured to be inserted into a recess 2210 of another shroud segment 2207 and the recess 2211 of the given shroud segment 2207 is configured to receive the protrusion 2209 of another shroud segment 2207 to secure the shroud segments 2207 together. For example, the protrusion 2209 of a shroud segment 2207 of a first blade 2200 is configured to be inserted into a recess 2210 of a second shroud segment 2207 of a second blade 2200. The protrusion 2209 contacts a portion of the second shroud segment 2207 that defines the recess 2210 of the second shroud segment thereby resulting in the second side of the shroud segment 2207 of the first blade 2200 being in contact with the first side of the shroud segment 2207 of the second blade 2200. Similarly, the recess 2210 of the shroud segment 2207 of the first blade 2200 is configured to receive a protrusion 2209 of a shroud segment 2207 of a third blade 2200 such that the protrusion 2209 contacts a portion of the shroud segment 2207 of the first blade 2200 that defines the recess 2210 of the first shroud segment. As a result, the second side of the shroud segment 2207 of the first blade is in contact with the first side of the shroud segment 2207 of the third blade 2200.

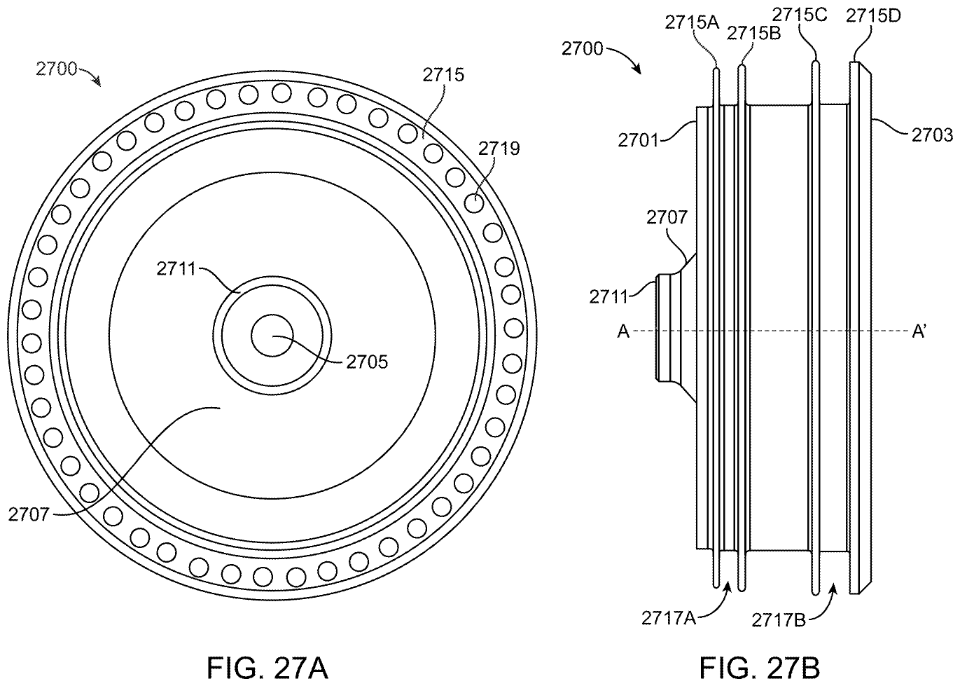

The second end 2203 of the blade 2200 is located at the root of the blade 2200. In one embodiment, the second end 2203 has a pin root design to secure the second end 2203 of the blade 2200 to a hub 2700 shown in FIGS. 27A and 27B. In one embodiment, the blade 2200 includes a dual pin root design as will be further described below.

In one embodiment, the second end 2203 includes a base 2211 and a plurality of mounting tabs 2213 (e.g., mounting portions, mounting pins, or pin roots) that extend perpendicularly away from the lower surface of the base 2211. As shown in FIG. 23C, the base 2211 extends from an end of the airfoil 2205 that is farthest from the first end 2201 of the blade such that a radius is formed between a surface of the base 2211 and the end of the airfoil 2205. The radius is formed to increase the strength of the blade 2200 thereby reducing a likelihood of the blade cracking at the interface between the base 2211 and the airfoil 2205.

In one embodiment, the base 2211 is curved along the length of the base 2211. More specifically, the base 2211 includes a first end and a second end that is opposite the first end. The portion of the base 2211 between the first end of the base 2211 and the second end of the base 2211 is curved such that the first end and the second end of the base are misaligned (e.g., offset from each other). The base 2211 includes a connection surface 2219 (e.g., edges) at a right side (e.g., left side) of the base and a connection surface 2219 at a second side (e.g., a left side) of the base 2211 where each of the connection surfaces 2219 follow the curvature of the base 2211. A connection surface 2219 of a blade 2200 is configured to connect to (e.g., contact) a connection surface 2219 of another blade 2200. In one embodiment, the base 2211 angles upward from the first end of the base 2211 to the second end of the base 2211 as shown in FIG. 22B.

In one embodiment, the mounting tabs 2213 are configured to attach the blade 2200 to the hub 2700. The mounting tabs 2213 include a first mounting tab 2213A and a second mounting tab 2213B. In one embodiment, the first mounting tab 2213A extends perpendicular from a lower surface of the first end of the base 2211 and the second mounting tab 2213B extends perpendicular from the lower surface of the second end of the base 2211 that is opposite the first end of the base 2211.

Due to the curvature the base 2211 from the first end of the base 2211 to the second end of the base 2211, the first mounting tab 2213A and the second mounting tab 2213B are misaligned with each other such that the second mounting tab 2213 is offset from the first mounting tab 2213 in the horizontal direction as shown in the front view of the blade 2200 shown in FIG. 22A. In one embodiment, a width of the first mounting tab 2213A and a width the second mounting tab 2213B are the same and the offset is equivalent to the matching width.

Furthermore, the length of the first mounting tab 2213A may be different from the length of the second mounting tab 2213B. In one embodiment, the length of the second mounting tab 2213B is greater than the length of the first mounting tab 2213A due to the base 2211 angling upward from the first end of the base 2211 to the second end of the base 2211 as shown in FIG. 22B. Although the first mounting tab 2213A and the second mounting tab 2213B have different lengths, the bottommost point of the first mounting tab 2213A is aligned with the bottommost point of the second mounting tab 2213B as in FIG. 22B.

Lastly, the thicknesses of the mounting tabs 2213 may be different as shown in the side view of the blade 2200 in FIG. 22B. In one embodiment, the thickness of the second mounting tab 2213B is thicker than a thickness of the first mounting tab 2213A. However, in other embodiments the first mounting tab 2213A and the second mounting tab 2213B have the same thickness.

In one embodiment, each of the mounting tabs 2213 includes a respective hole in the mounting tab. For example, the first mounting tab 2213A includes a first hole 2215A and the second mounting tab 2213B includes a second hole 2215B. A center of the first hole 2215A and a center of the second hole 2215B are misaligned (e.g., offset) with each other due to the misalignment of the mounting tabs 2213 as shown in the front view of the blade 2200 shown in FIG. 22A.

As will be described in further detail below, a fastening mechanism such as a fastening pin is configured to be inserted into the first hole 2215A of one blade 2200 and into the second hole 2215B of a second blade to connect the first and second blades to the hub 2700. By securing the roots of the blades 2200 using the dual pin hole root design, the pitch (e.g., angle) of the roots of the blades 2200 is substantially the same during thrust generation or while the propulsor fan 100 is at rest thereby reducing noise pollution.

The airfoil 2205 is disposed between the first end 2201 and the second end 2203 of the blade 2200. In one embodiment, the airfoil 2205 comprises a geometric twist 2217 in the airfoil 2205. The geometric twist 2217 is a change in airfoil angle of incidence measured with respect to the root of the blade 2200. That is, the airfoil 2205 includes a plurality of different angles of incidence across the length of the airfoil 2205 due to the geometric twist 2217. For example, the airfoil 2205 may have a first angle of incidence at a first side of the geometric twist 2217 (e.g., below the geometric twist 2217 in FIG. 22A) and may have a second angle of incidence at a second side of the geometric twist 2217 (e.g., above the geometric twist 2217 in FIG. 22A).

As a result of the geometric twist 2217, the first end 2201 and the second end 2203 are misaligned from each other when viewed from the top view of the blade 2200 as shown in FIG. 22C. In one embodiment, the geometric twist 2217 begins at a portion of the airfoil 2205 that is closer to the second end (e.g., the root) of the blade 2200 than the first end 2201 (e.g., the tip) of the blade 2200. The geometric twist between the root and tip chord may vary as much as 45 degrees.

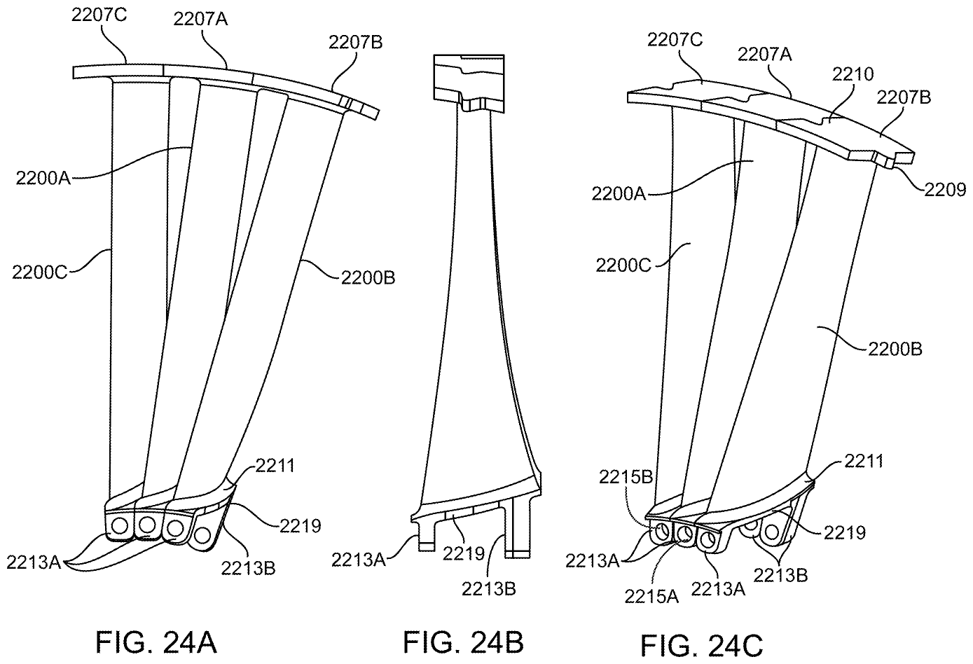

FIGS. 24A, 24B, and 24C respectively illustrate a front view, a side view, and a perspective view of a plurality of interlocked blades 2200 each with the dual pin-root according to the second embodiment. As shown in FIGS. 24A to 24C, the plurality of blades 2200 include a first blade 2200A, a second blade 2200B at a first side (e.g., a right side) of the first blade 2200A, and a third blade 2200C at a second side (e.g., a left side) of the first blade 2200A. The plurality of blades 2200 are connected to each other such that the shroud segments 2207 of the blades 2200 are interlocked with each other to form a portion of the tip shroud that is disposed around the circumference of a blade fan.

For example, the protrusion 2209 of a first shroud 2207A of the first blade 2200A is inserted into the recess 2210 of the second shroud 2207B of the second blade 2200B such that the edges of the first side of the first shroud 2207A are in contact with the edges of the second side of the second shroud 2207B as shown in FIGS. 24A to 24C. Similarly, the protrusion 2209 of a third shroud 2207C of the third blade 2200C is inserted into the recess 2210 of the first shroud 2207A of the first blade 2200A such that the edges of the first side of the third shroud 2207C are in contact with the edges of the second side of the first shroud 2207A as shown in FIGS. 24A to 24C.

Furthermore, the connection surfaces 2219 of the base 2211 of each blade 2200 is in contact with connection surfaces 2219 of bases 2211 of adjacent blades 2200. For example, the connection surface 2219 on the right side of the base 2211 of the first blade 2200A is in contact with the connection surface 2219 on the left side of the base 2211 of the second blade 2200B. Similarly, the connection surface 2219 on the right side of the base 2211 of the third blade 2200C is in contact with the connection surface 2219 on the left side of the base 2211 of the first blade 2200A.

As mentioned above, the mounting tabs 2213 of a given blade 2200 are misaligned with each other. However, while the blades 2200 are connected to each other as shown in FIGS. 24A to 24C, the center of the first hole 2215A included in the first mounting tab 2213A of a given blade 2200 is aligned with the center of the second hole 2215B included in the second mounting tab 2213B of another blade 2200. For example, the center of the first hole 2215A in the first mounting tab 2213A of the first blade 2200A is aligned with the center of the second hole 2215B in the second mounting tab 2213B of the third blade 2200C.

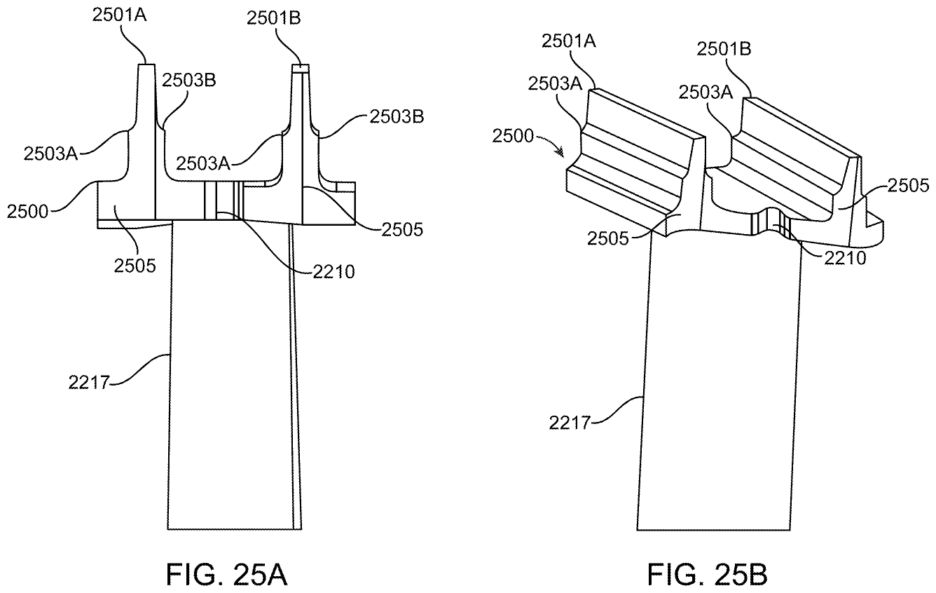

FIGS. 25A and 25B respectively illustrate a front view and a perspective view of a shroud segment 2500 according to another embodiment. The shroud segment 2500 includes the features of the shroud segment 2207 previously described above. In addition, the shroud segment 2500 includes a plurality of knife edge segments 2501 in one embodiment. The knife edge segments 2501 improve control of air tip leakage across the inter-locking tip shroud and provide favorable fan blade clearance-to-span for improved performance and retention. That is, the knife edge segments function as dams that reduce air leakage to areas aft of the blade fan.

In one embodiment, the plurality of knife edge segments 2501 include a first edge segment 2501A and a second edge segment 2501B. Each knife edge segment 2501 is a protrusion that protrudes from an upper surface of the shroud segment 2500. In one embodiment, each knife edge segment 2501 extends from the first side of the shroud segment 2500 with protrusion 2209 to the second side of the shroud segment 2500 with the recess 2210. In the example shown in FIGS. 25A and 25B, the heights of the plurality of knife edge segments 2501 are the same. That is, the first knife edge segment 2501A has a same height as the second knife edge segment 2501B.

In one embodiment, side surfaces of each knife edge segment 2501 include a plurality of steps 2503 that increase the surface area of the shroud segment 2500 to further improve reduction of air leakage across the blade fan. Thus, the side surfaces of each knife edge segment 2501 does not linearly extend from the upper surface of the shroud segment 2500 to the tip of the knife edge segment 2501. Rather, each side surface includes one or more steps in the side surface to increase the surface area of the shroud segment 2500. For example, the first knife edge segment 2501A includes a first step 2503A at a first side of the first knife edge segment 2501A and a second step 2503B at a second side of the first knife edge segment 2501A. Similarity, the second knife edge segment 2501B includes a first step 2503A at a first side of the second knife edge segment 2501B and a second step 2503B at a second side of the second knife edge segment 2501B.

In one embodiment, each knife edge segment 2503 has a plurality of connection surfaces 2505 that are configured to connect to (e.g., contact) connection surfaces of other knife edge segments 2503. Each knife edge segment 2503 has a first connection surface 2505 at the first side of the shroud segment 2500 and a second connection surface 2505 at the second side of the shroud segment 2500. The connected knife edge segments 2503 collectively form one or more knife edge seals around the circumference of the tip shroud as further described below.

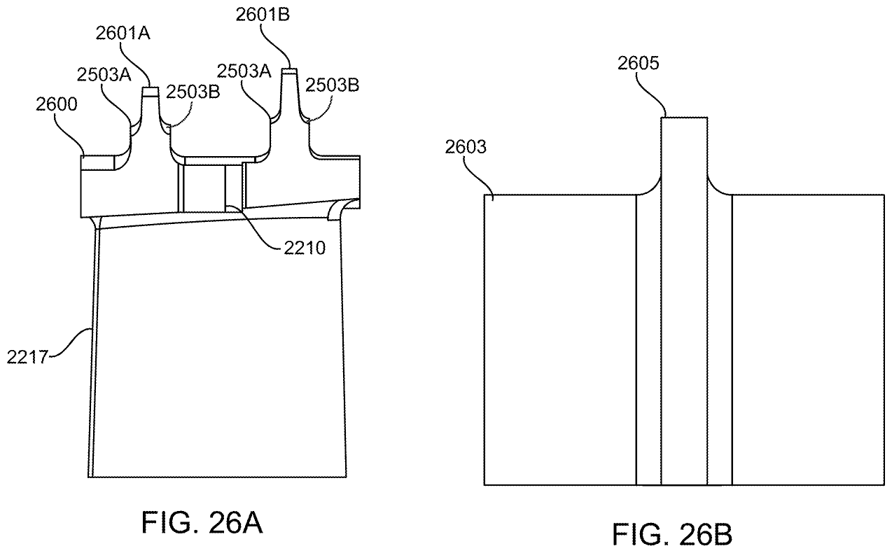

FIG. 26A a front view of a shroud segment 2600 according to another embodiment. The shroud segment 2600 includes similar features of the shroud segment 2500 described in FIGS. 25A and 25B. For example, the shroud segment 2600 includes knife edge segments 2601A and 2601B that each include steps 2503A and 2503B. However, the knife edge segments 2601 have different heights in the embodiment shown in FIG. 26A. For example, the first knife edge segment 2601A has a height that is less than a height of the second knife edge segment 2601B. The second knife edge segment 2601B is closer to the aft end of the blade fan than the first knife edge segment 2601B and further prevents unwanted air from propagating aft of the blade fan.

FIG. 26B a front view of a shroud segment 2603 according to another embodiment. The shroud segment 2603 includes similar features as the shroud segment 2207 in addition to a single knife edge segment 2605. The single knife edge segment 2605 is aligned with the recess 2210 and protrusion 2205 and extends from the first side of the shroud segment 2603 with protrusion 2209 to the second side of the shroud segment 2603 with the recess 2210 in one embodiment. However, the single knife edge segment 2605 may be placed at other locations along the upper surface of the shroud segment 2603 in other embodiments.

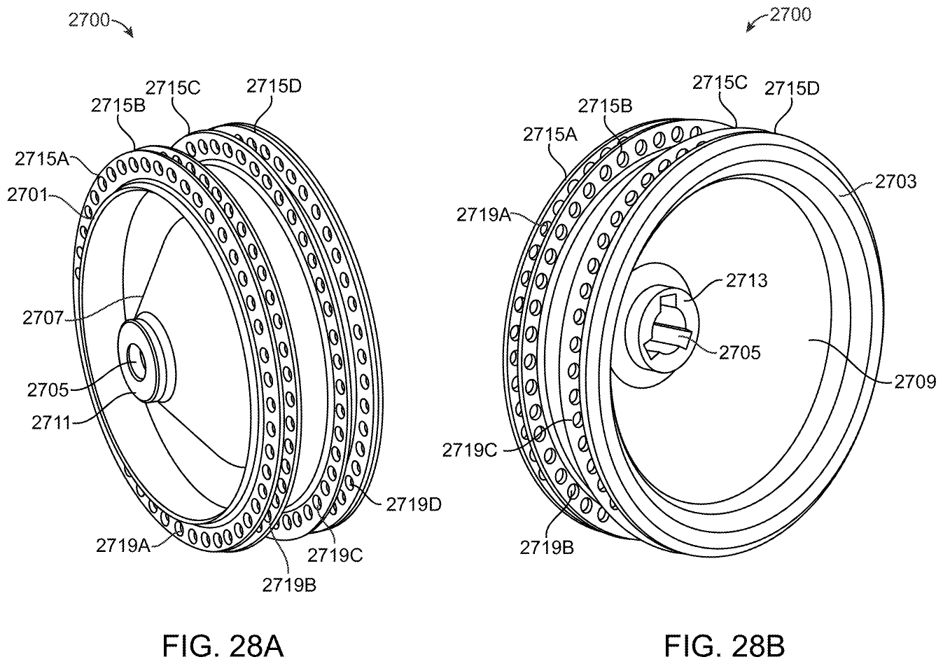

FIGS. 27A and 27B respectively illustrate a front view and a side view of a hub 2700 according to one embodiment. FIGS. 28A and 28B respectively illustrate a perspective view of a first end 2701 of the hub 2700 and a perspective view of a second end 2703 of the hub 2700 according to one embodiment. The hub 2700 is configured to be connected to blades 2200 having the dual-pin root as previously described above.

The hub 2700 is the central portion of the blade fan and is disposed at a center of the blade fan as will be further described below. The hub 2700 is configured to connect to the nose cone 203 and the motor 215 in one embodiment. Due to the different design of the hub 2700 compared to hub 205 previously described above, the nose cone 203 and motor 215 have modified connection points according to the connection points of the hub 2700.

As shown in FIGS. 27A, 27B, 28A, and 28B, the hub 2700 is cylindrical in shape in one example. The diameter of a first end 2701 of the hub 2700 is different from a diameter of the second end of the hub 2700 in one embodiment. The first end 2701 of the hub 2700 has a diameter that matches a diameter of the second end of the nose cone 203 whereas the second end 2703 of the hub 2700 has a diameter that matches a diameter of the motor 215 in one embodiment.

The hub 2700 may include a raised portion 2707 as shown in FIGS. 28A and 28B. In one embodiment, the raised portion 2707 has a conical shape that extends from the second end 2703 of the hub 2700 toward the first end 2701 of the hub 2700. As shown in FIG. 27B, the raised portion 2707 extends past the first end 2701 of the hub 2700. That is, the end of the raised portion 2707 protrudes past the first end 2701 of the hub 2700. As shown in FIG. 28B, the raised portion 2707 forms a cavity 2709 in the second end 2703 of the hub 2700 in which at least a portion of the motor 215 may be disposed. Since at least a portion of the motor 215 is disposed within the cavity 2709 of the hub 2700, the overall length of the propulsor fan 100 may be reduced.

In one embodiment, a nose cone mounting point 2711 is located at the end of the raised portion 2707. The nose cone mounting point 2711 is configured to contact the nose cone 213. The nose cone mounting point 2711 may be cylindrical in shape with a flat surface. In one embodiment, the nose cone mounting point includes an opening 2705. The opening 2705 is positioned at a center of the hub 2700 and extends through a thickness of the hub 2700. A center of the opening 2705 is configured to be aligned with a center of the air channel 413 of the nose cone 203. Thus, air flow exiting the air channel 413 of the nose cone 203 flows through the opening 2705 in the hub 2700 to cool the motor 215.

In one embodiment, a motor mounting point 2713 is located in the cavity 2709. The motor mounting point 2713 is configured to contact the motor 215. The motor mounting point 2713 may be cylindrical in shape with a flat surface. In one embodiment, the opening 2705 extends through the thickness of the motor mounting point 2713 as shown in FIG. 28B. A center of the opening 2705 in the motor mounting point 2713 is aligned with the center of the opening 2705 in the nose cone mounting point 2711.

In one embodiment, the diameter of the opening 2705 in the nose cone mounting point 2711 is different from the diameter of the opening 2705 in the motor mounting point 2713 as shown in FIGS. 28A and 28B. For example, the diameter of the opening 2705 in the motor mounting point 2713 is greater than the opening 2705 in the nose cone mounting point 2711. In one embodiment, the opening 2705 in the motor mounting point 2713 is configured to receive an output shaft of the motor 215. That is, the output shaft of the motor 215 is inserted into opening 2705 in the motor mounting point 2713. The output shaft of the motor 215 is contact with the inner surface of the hub 2700 disposed within the opening 2705 to connect the output shaft of the motor 215 to the hub 2700. As the output shaft of the motor 215 rotates, the hub 2700 also rotates thereby rotating the blade fan connected to the hub 2700.

The hub 2700 includes a plurality of blade mounting flanges 2715 configured to connect the blades 2200 to the hub 2700. In one embodiment, the plurality of blade mounting flanges 2715 include a first blade mounting flange 2715A, a second blade mounting flange 2715B, a third blade mounting flange 2715C, and a fourth blade mounting flange 2715D. Each blade mounting flange 2715 is a circular ring that extends radially from the outer surface of the hub 2700. The blade mounting flanges 2715 are disposed on a portion of the outer surface of the hub that is between the first end 2701 and the second end 2703 of the hub.

In one embodiment, the blade mounting flanges 2715 are spaced apart from each other such that slots 2717 are formed between the blade mounting flanges 2615 as shown in FIG. 27B. The slots 2717 are formed along the circumference of the hub 2700. For example, a first slot 2717A is formed between the first blade mounting flange 2715A and the second blade mounting flange 2715B as shown in FIG. 27B. Furthermore, a second slot 2717B is formed between the third blade mounting flange 2715C and the fourth blade mounting flange 2715D as shown in FIG. 27B. The width of the first slot 2717A matches the thickness of the first mounting tab 2213A and the width of the second slot 2717B matches the thickness of the second mounting tab 2213B.

In one embodiment, the blade mounting flanges 2715 include a plurality of holes 2719. Each blade mounting flange 2715A, 2715B, 2715C, and 2715D includes a respective set of holes 2719. For example, the first blade mounting flange 2715A includes a plurality of first holes 2719A through the entire thickness of the first blade mounting flange 2715A. The first holes 2719A are spaced apart from each other with uniform spacing around the circumference of the first blade mounting flange 2715A. The second blade mounting flange 2715B includes a plurality of second holes 2719B through the entire thickness of the second blade mounting flange 2715B. The second holes 2719B are spaced apart from each other with uniform spacing around the circumference of the second blade mounting flange 2715B. The third blade mounting flange 2615C includes a plurality of third holes 2719C through the entire thickness of the third blade mounting flange 2715C. The third holes 2719C are spaced apart from each other with uniform spacing around the circumference of the third blade mounting flange 2615C. Lastly, the fourth blade mounting flange 2715D includes a plurality of fourth holes 2719D. Unlike the first to third holes 2719A to 2719C, the fourth holes 2719D extend partially through the entire thickness of the fourth blade mounting flange 2715D. That is, the fourth holes 2719 do not extend through the entire thickness of the fourth blade mounting flange 2715D. The fourth holes 2719D are spaced apart from each other with uniform spacing around the circumference of the fourth blade mounting flange 2715D.

In one embodiment, the centers of the first holes 2719A, the centers of the second holes 2719B, the centers of the third holes 2719C, and the centers of the fourth holes 2719B are aligned to collectively form rows of holes 2719 around the circumference of the hub 2700. That is, a center of each first hole 2719A is aligned with a center of a corresponding second hole 2179B, a center of a corresponding third hole 2719B, and a center of a corresponding fourth hole 2719D where the first hole 2719A, the second hole 2719B, the third hole 2719C, and the third row 2719D are in the same row of holes. In one embodiment, the slots 2717 and holes 2719 of the hub 2700 are configured to connect the blades 2200 to the hub 2700 as will be further described below.

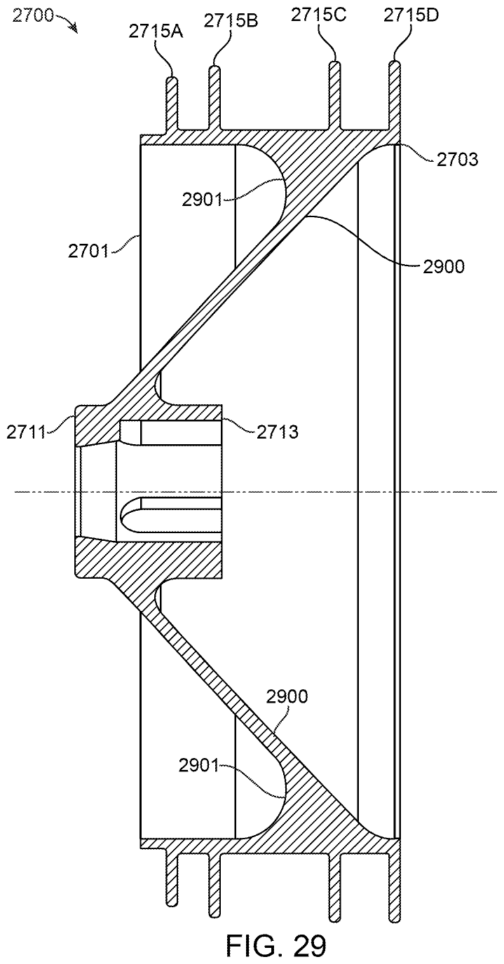

FIG. 29 is a cross-section view of the hub 2700 along line A-A′ in FIG. 27B according to one embodiment. As shown in FIG. 29, the hub 2700 includes webbings 2900 that extend from the center of the hub 2700 toward the second end 2703 of the hub 2703. The thickness of the webbings 2900 is different along the length of the webbings 2900. As shown in FIG. 29, the end of the webbings 2900 at the second end 2703 of the hub 2700 is thicker than the intermediate portions of the webbings 2900 that are located between the second end 2703 of the hub and the end of the webbings 2900 that extend from the center of the hub 2703. The end of the webbings 2900 at the second end of the hub 2700 include radius portions 2901 to increase strength of the hub 2700.

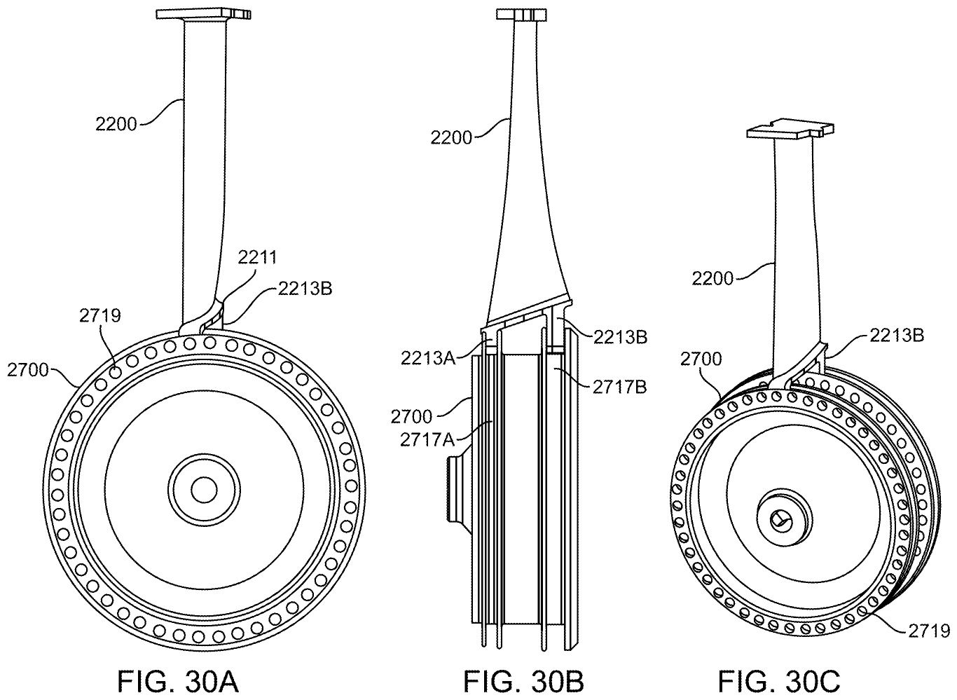

FIGS. 30A, 30B, and 30C respectively illustrate a front view, a side view, and a perspective view of a blade 2200 with the dual pin hole root that is connected to the hub 2700 according to one embodiment. The mounting tabs 2213 of the blade 2200 are configured to be inserted into the slots 2717 of the hub 2700. Specifically, the first mounting tab 2213A of the blade 2200 is inserted into the first slot 2171A formed between the first blade mounting flange 2715A and the second blade mounting flange 2715B. Furthermore, the second mounting tab 2213B of the blade 2200 is inserted into the second slot 2171B formed between the third blade mounting flange 2715C and the fourth blade mounting flange 2715D.

While the first mounting tab 2213A is inserted into the first slot 2717A, the center of the first hole 2215A in the first mounting tab 2213A is aligned with the center of a hole 2719A in the first blade mounting flange 2715A and the center of a hole 2719B in the second blade mounting flange 2715A where the centers of holes 2719A and 2719B in the first and second blade mounting flanges 2715A are aligned with each other. Similarly, while the second mounting tab 2213B is inserted into the second slot 2717B, the center of the second hole 2215B in the second mounting tab 2213B is aligned with the center of a hole 2719C in the third blade mounting flange 2715C and the center of a hole 2719D in the fourth blade mounting flange 2715D where the centers of holes 2719C and 2719D in the third and fourth blade mounting flanges 2715D are aligned with each other. However, due to the offset between the first mounting tab 2213A and the second mounting tab 2213B, the center of the holes 2719A and 2719B that align with the center of the first hole 2215A in the first mounting tab 2213A are misaligned with the center of the holes 2719C and 2719D that align with the center of the second hole 2215B in the second mounting tab 2213B. This is due to holes 2719A and 2719B in the first and second blade mounting flanges 2715A, 2715B being in a first row of holes whereas holes 2719B and 2719D in the third and fourth blade mounting flanges 2715C, 2715D are in a second row of holes that is adjacent to the first row of holes.

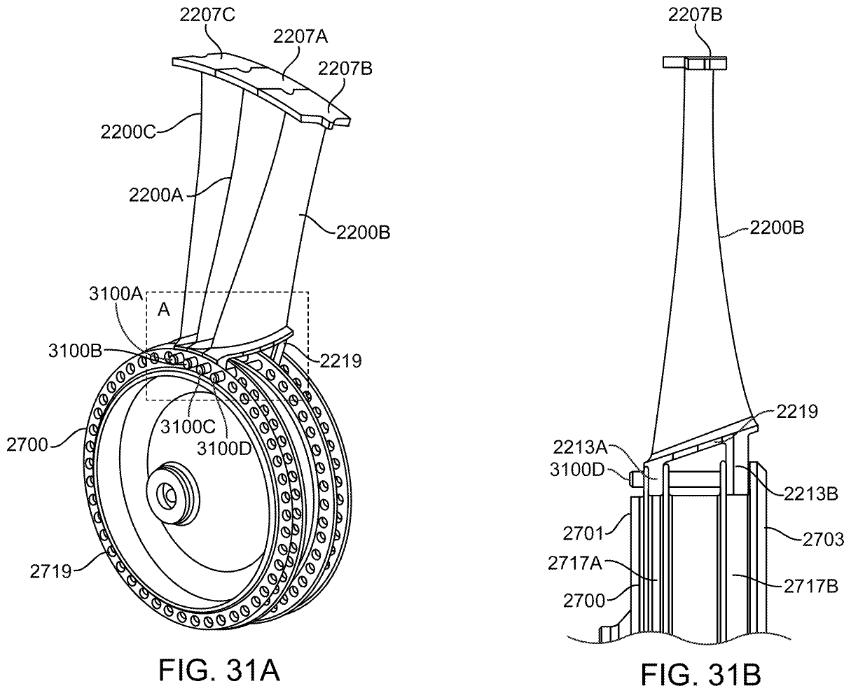

FIGS. 31A and 31B respectively illustrate a perspective view and a side view of a plurality of interconnected blades 2200 with the dual pin hole root that are connected to the hub 2700 according to one embodiment. As shown in FIGS. 31A and 31B, the plurality of blades 2200 are connected to the hub 2700 using a plurality of fasteners 3100. In one embodiment, the fasteners are pin fasteners as shown in FIGS. 31A and 31B, but other types of fasteners may be used. While the plurality of blades 2200 are connected to hub 2700, the shroud segments 2707 of the blades 2200 are interlocked together and the connection surfaces 2219 of the bases 2211 of the blades 2200 are connected to each other as described with respect to FIGS. 24A to 24C. When all of the plurality of blades are attached to the hub 2700, a circular tip shroud is formed at the second ends of the blades 2200 as will be further described below.

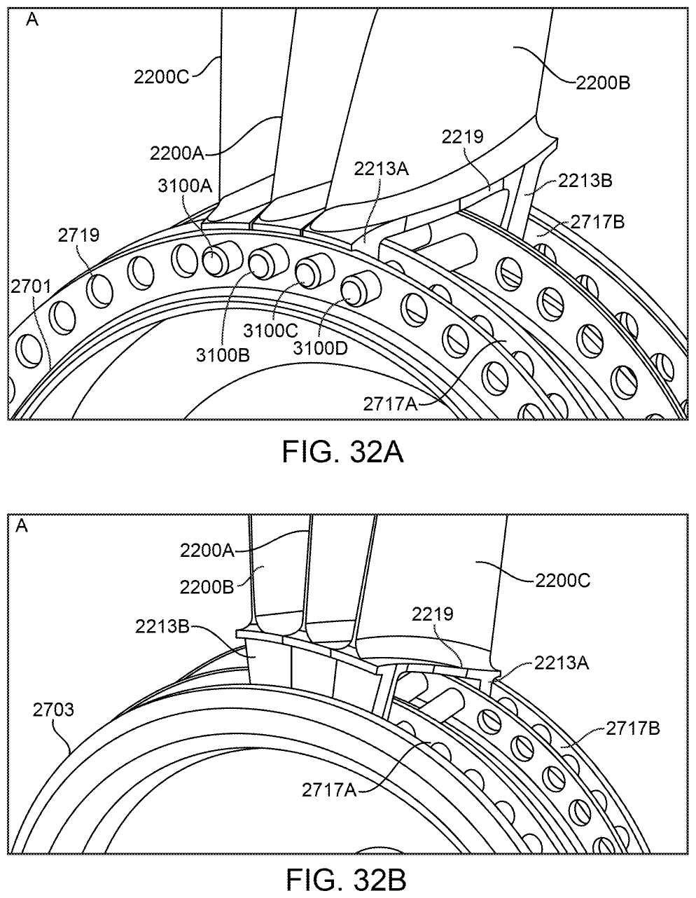

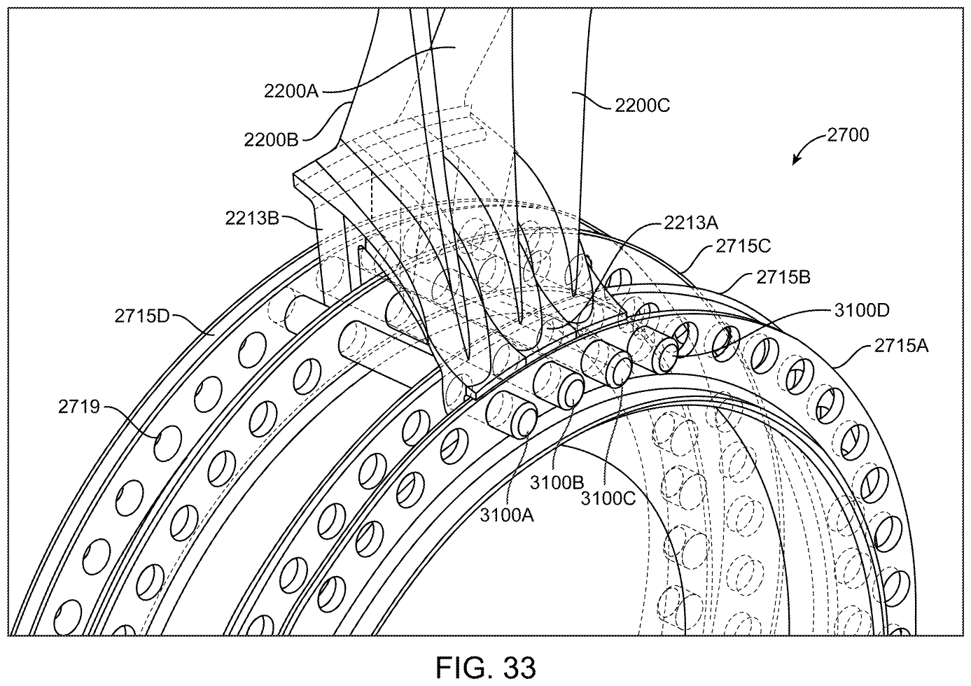

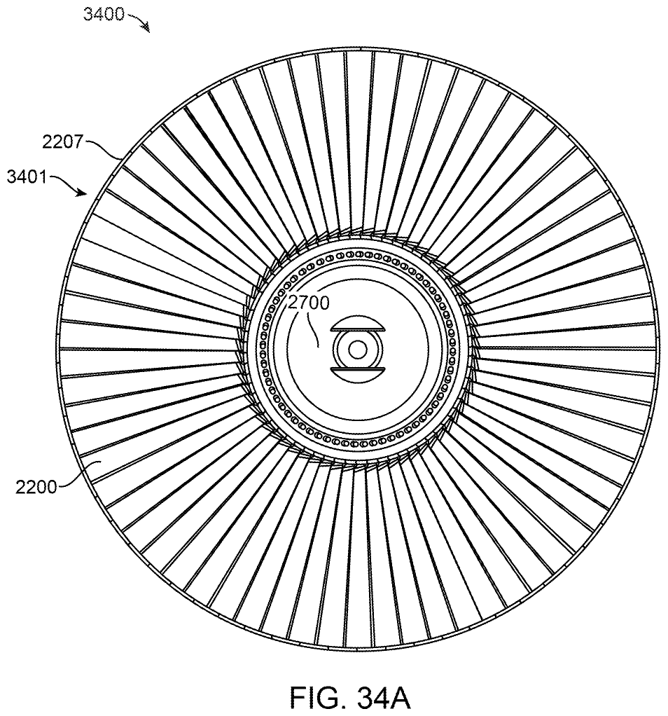

FIGS. 32A and 32B respectively illustrate a detailed perspective view of region A in FIG. 31A from the perspective of the the first end 2701 of the hub 2700 with the plurality of blades 2200 attached to the hub 2700 using fasteners 3100 and a detailed perspective view of region A in FIG. 31A from the perspective of the second end 2703 of the hub 2700 with the plurality of blades 2200 attached to the hub 2700 using fasteners 3100. FIG. 33 illustrates a wireframe view of the first end 2701 of the hub 2700 with the plurality of blades 2200 attached to the hub 2700 using fasteners 3100

Due to the offset between the first mounting tab 2213A and the second mounting tab 2213B of each blade, a single fastener 3100 cannot connect the blade 2200 to the hub 2700. Rather, a plurality of fasteners 3100 (e.g., two) are required to connect each blade 2200 to the hub 2700. The plurality of fasteners 3100 to connect each blade 2200 to the hub 2700 includes a first fastener and a second fastener.

The first fastener is inserted through 1) a first hole in the blade mounting flange 2715A, 2) a first hole in the second blade mounting flange 2715B that is aligned with the first hole in the first blade mounting flange 2715A, and 3) the first hole 2215A in the first mounting tab 2213A of the blade 2200 that is disposed between the first hole in the first blade mounting flange 2715A and the first hole in the second blade mounting flange 2715B to secure the first mounting tab 2213A of the first blade to the hub 2700. The first fastener is also inserted into 4) the first hole in the third blade mounting flange 2715C and 5) the first hole in the fourth blade mounting flange 2715D that are aligned with the first holes in the first and second blade mounting flanges 2715B, and 6) the second mounting tab 2213B of a first neighboring blade 2200 that is disposed between the first hole in the third blade mounting flange 2715C and the first hole in the fourth blade mounting flange 2715D where the first neighboring blade 2200 is directly adjacent to the blade 2200 at a first side (e.g., left side) of the blade 2200.

Since the second mounting tab 2213B of the blade 2200 is offset from the first mounting tab 2213A of the blade 2200, the second mounting tab 2213B of the blade is not connected to the hub 2700 using the first fastener. Rather, the second mounting tab 2213B of the blade 2200 is connected to the hub 2700 using a second fastener that is used to connect the first mounting tab 2213A of a second neighboring blade 2200 to the hub 2700 where the second neighboring blade 2200 is directly adjacent to a second side (e.g., a right side) of the blade 2200.

The second fastener is inserted through 1) a second hole in the first blade mounting flange 2715A that is directly adjacent to the first hole in the first blade mounting flange 2715A, 2) a second hole in the second blade mounting flange 2715B that is aligned with the second hole in the first blade mounting flange 2715A where the second hole in the second blade mounting flange 2715B is directly adjacent to the first hole in the second blade mounting flange 2715B, and 3) the first hole 2215A in the first mounting tab 2213A of the second neighboring blade 2200 that is disposed between the second hole in the first blade mounting flange 2715A and the second hole in the second blade mounting flange 2715B to secure the first mounting tab 2213A of the second neighboring blade 2200 to the hub 2700.

The second fastener is also inserted into 4) the first hole in the third blade mounting flange 2715C, 5) the first hole in the fourth blade mounting flange 2715D that is aligned with the first holes in the first and second blade mounting flanges 2715B, and 6) the second mounting tab 2213B of a blade 2200 that is disposed between the first hole in the third blade mounting flange 2715C and the first hole in the fourth blade mounting flange 2715D to secure the blade to the hub 2700.

Referring to FIG. 33 as an example of how the first blade 2200A is connected to the hub 2700, a first fastener 3100B is inserted through a first hole 2719 of the first blade mounting flange 2715A, a first hole 2719 of the second blade mounting flange 2715B, and the first mounting tab 2213A of the first blade 2200A. However, the first fastener 3100B does not secure the second mounting tab 2213B of the first blade 2200A to the hub 2700. Rather, a second fastener 3100C is used to secure the second mount tab 2213B of the first blade 2200A to the hub 2700.

The second fastener 3100C is inserted through a second hole 2719 of the first blade mounting flange 2715A that is directly adjacent to the first hole 2719 in the first blade mounting flange 2715A through which the first fastener 3100B is inserted, a second hole 2719 of the second blade mounting flange 2715B that is directly adjacent to the first hole 2719 in the second blade mounting flange 2715B through which the first fastener 3100B is inserted, and a first hole of the first mounting tab 2213A of the second blade 2200C that neighbors the first blade 2200A. The second fastener 3100C is also inserted through a second hole 2719 of the third blade mounting flange 2715C, a second hole 2719 of the fourth blade mounting flange 2715D, and a second hole 2215B in the second mounting tab 2213B of the first blade 2200A that is inserted between the second hole 2719 of the third blade mounting flange 2715C and the second hole 2719 of the fourth blade mounting flange 2715D to secure the first blade 2200A to the hub 2700. The remaining blades 2200 are attached to the hub 2700 in this manner to form the blade fan of blades having dual pin roots and a tip shroud.

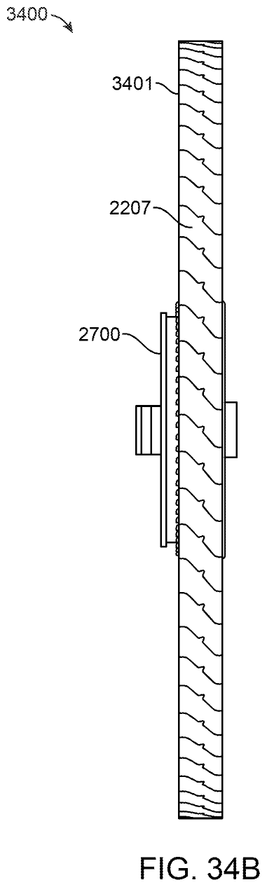

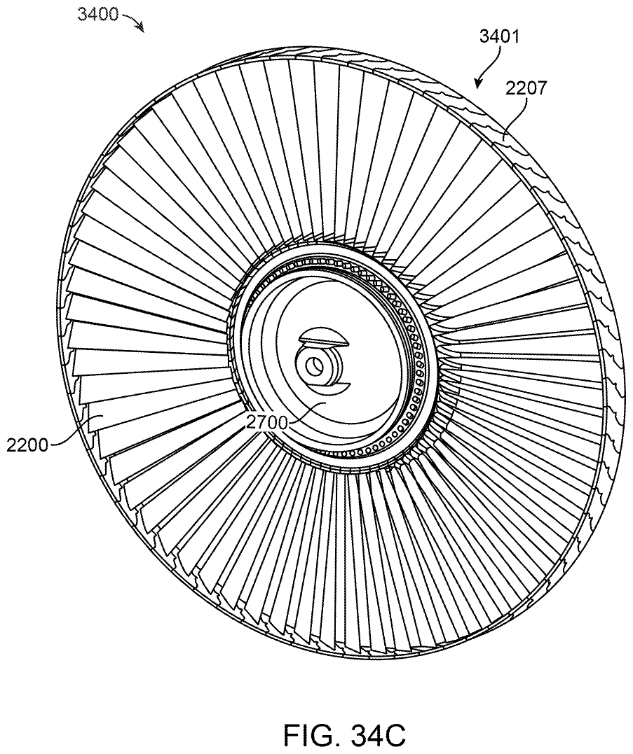

FIGS. 34A, 34B, and 34C respectively illustrate a front view, a side view, and a perspective view of a blade fan 3400 with a tip shroud 3401 for use in the propulsor fan 100 according to one embodiment. As previously described above, the tip shroud 3401 is collectively formed from the connected shroud segments 2207. The blade fan 3400 includes blades 2200 with the dual pin root as described above. The blade fan 3400 can have any number of blades 2200 dependent on the application. In one embodiment, the material for the blades 2200 of the blade fan 3400 is also dependent on the type of application of the blade fan 3400. The blades 2200 may be made of metal such as aluminum or titanium or a composite such as carbon fiber. Note that in other embodiments, the blade fan may have the dual pin root as previously described above without the tip shroud 3401.

As shown in FIGS. 34A, 34B, and 34C, the plurality of blades 2200 are arranged to form a circular ring shape with a hollow center where the hub 2700 is disposed. Each blade 2200 is positioned such that at least a portion of the leading edge and trailing edge of the blade 2200 are overlapped by neighboring blades 2200. For example, a leading edge of a given blade 2200 is overlapped by the trailing edge of a blade 2200 to the left of the given blade 2200 and a trailing edge of the given blade 2200 is overlapped by a leading edge of a blade 2200 to the right of the given blade 2200. The overlapping arrangement of the plurality of blades 601 provides increased solidity to perform work on the incoming stream of air. Tuning of this solidity takes into account localized aerodynamic effects and can be tuned to account for Reynolds number effects that may affect laminar attachment of flow in and between blades 2200.

As shown in FIGS. 34A, 34B, and 34C, the shroud segments 2207 of the blades 2200 are interlocked together to tension the tips of the blades 2200 such that a pitch of the blades 2200 during thrust generation is substantially the same as a pitch of the blades 2200 at rest. That is, by tensioning the tips of the blades 2200, the same shape and twist of the blades is maintained during thrust generation and at rest thereby reducing noise that may result from changes in the angle of the blades. The interlocked shroud segments 2207 of the blades 2200 collectively form the tip shroud that prevents or at least reduces blade vibration at the tips of the blades 2200. The reduced blade vibration enables a high blade count, high aspect ratio fan rotor design.

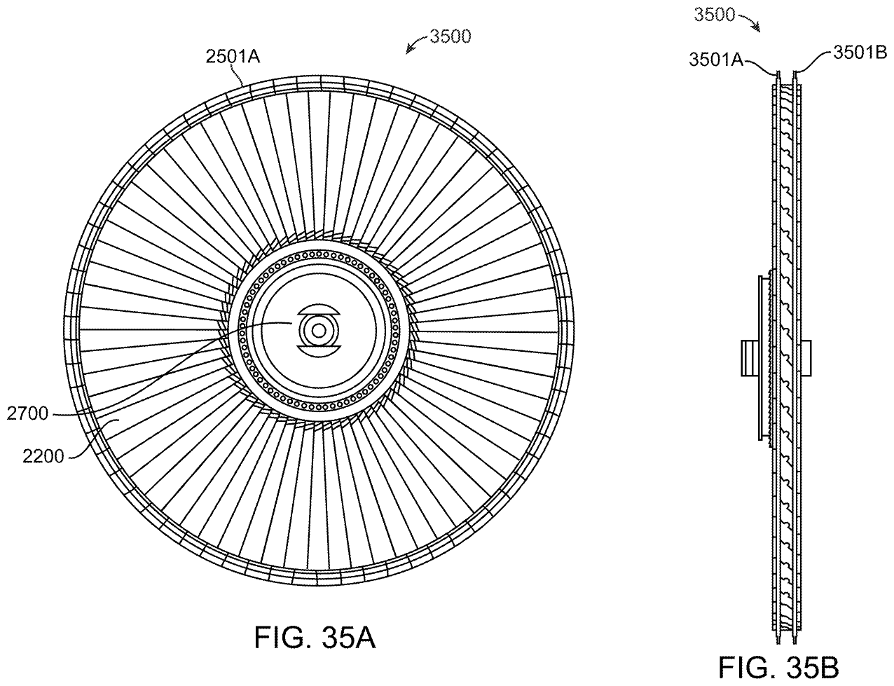

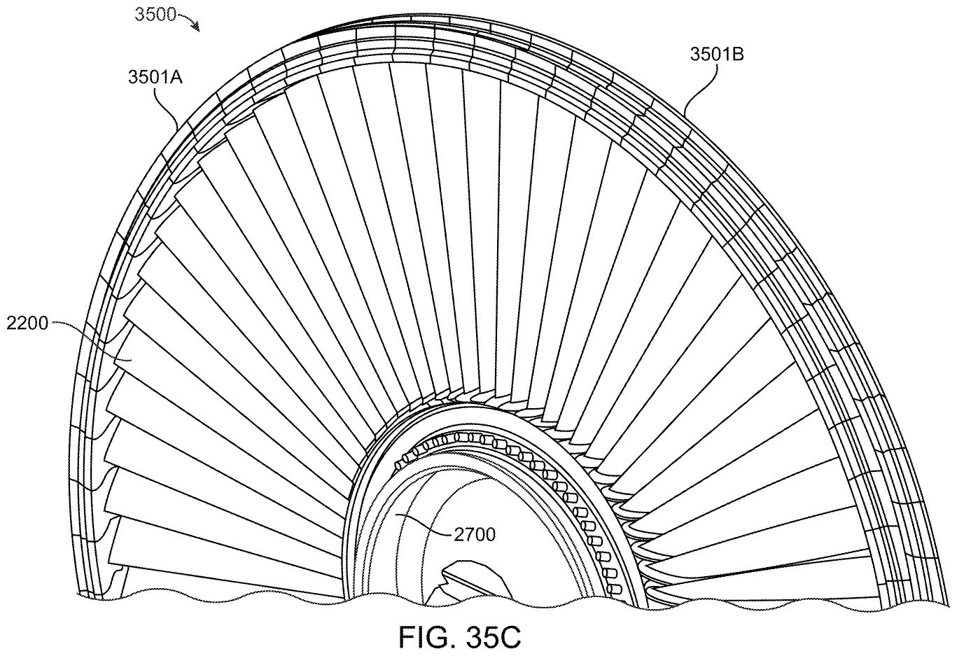

FIGS. 35A, 35B, and 35C respectively illustrate a front view, a side view, and a perspective view of a blade fan 3500 of the propulsor fan 100 according to one embodiment. The blade fan 3500 is similar to the blade fan 3400 except the blade fan 3500 includes a plurality of knife edge seals 3501 formed around the circumference of the blade fan 3500 (e.g., around the circumference of the tip shroud). In one embodiment, the knife edge seals 3501 include a first knife edge seal 3501A formed around the circumference of the blade fan 3500 and a second knife edge seal 3501B formed around the circumference of the blade fan 3500. In one embodiment, the first knife edge seal 3501A and the second knife edge seal 3501B are spaced apart from each other. The first knife edge seal 3501A is disposed closer to a first side of the blade fan 3500 that is configured to connect to the nose cone 203 whereas the second knife edge 3501B is disposed closer to a second side of the blade fan 3500 that is configured to connect to the motor 215.

The first knife edge seal 3501A comprises the plurality of first knife edge segments 2501A extending from the plurality of shroud segments 2500 of the plurality of blades 2200. As mentioned previously, each first knife edge segment 2501A is configured to be connected to other first knife edge segments 2501A of the plurality of blades 2200. Similarly, the second knife edge 3501B comprises the plurality of second knife edge segments 2501B extending from the plurality of shroud segments 2500 of the plurality of blades 2200 in the blade fan 3500. As mentioned previously, each second knife edge segment 2501B is configured to be connected to other second knife edge segments 2501B of the plurality of blades 2200. The interconnected first knife edge segments 2501A form the first knife edge seal 3501A and the interconnected second knife edge segments 2501B form the second knife edge seal 3501B.

The blade fan 3500 shown in FIG. 35 has a first knife edge seal 3501A and a second knife edge seal 3501B that have a same height due to the first knife edge segments 2501A and second knife edge segments 2501B having a same height as described above with respect to FIGS. 25A and 25B. In alternative embodiments the first knife edge seal 3501A and the second knife edge seal 3501B may have different heights due to the first knife edge segments 2601A and second knife edge segments 2601B having different heights as described above with respect to FIGS. 26A and 26B.

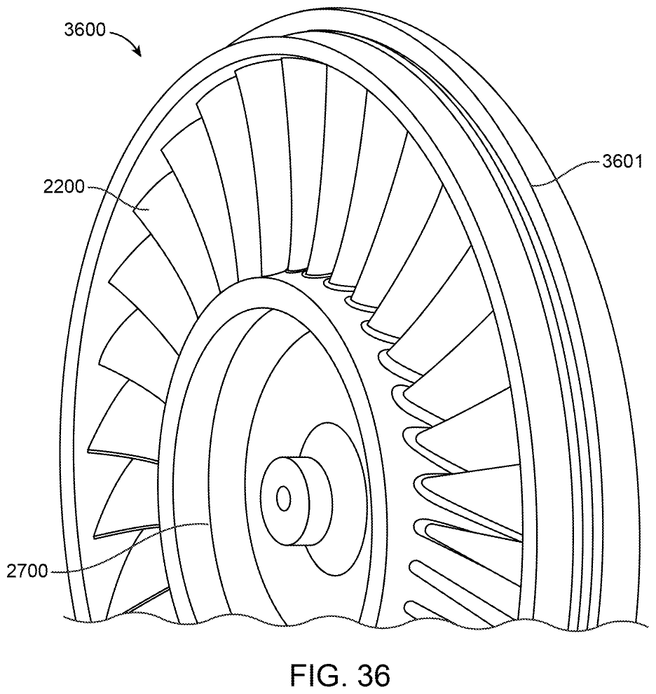

FIG. 36 illustrates a perspective view of a blade fan 3600 of the propulsor fan 100 according to one embodiment. The blade fan 3600 is similar to the blade fan 3500 except the blade fan 3600 includes a single knife edge seal 3601 formed around the circumference of the blade fan 3600. The single knife edge seal 3601 is formed along the center of the tip shroud that encircles the blades. The single knife edge seal 3601 comprises the plurality of single knife edge segments 2605 (shown in FIG. 26B) of the plurality of blades 2200 included in the blade fan 3600. As mentioned previously, each single knife edge segment 2605 is configured to be connected to other single knife edge segments 2605 of the plurality of blades 2200.

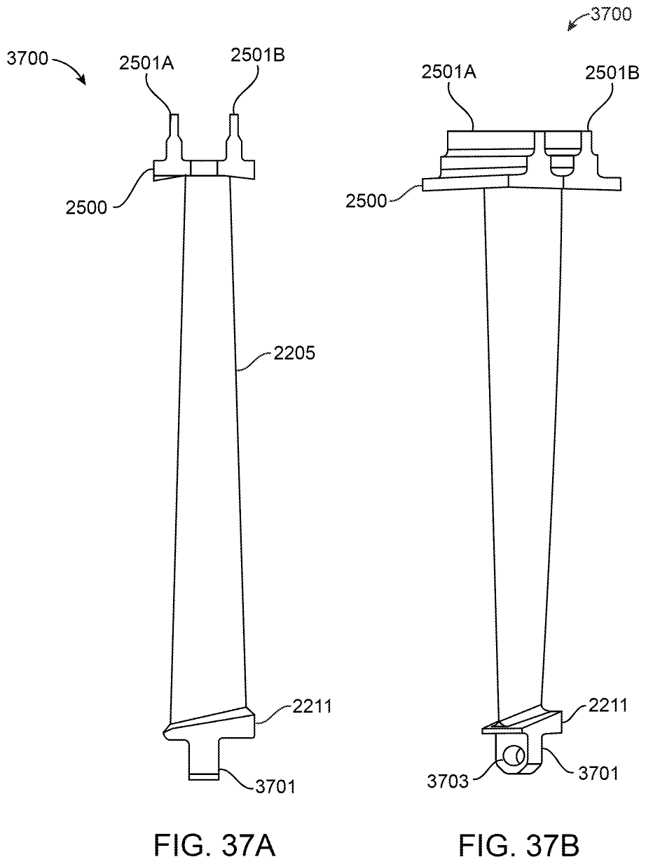

FIGS. 37A and 37B respectively illustrate a side view and a perspective view of a blade 3700 with a plurality of knife edge segments and a single pin hole root according to a third embodiment. The blade 3700 includes similar features as the blade 2200 described above with respect to FIGS. 22-23 and 25A and 25B such as the shroud segment 2500 with knife edge segments 2501A and 2501B at a first end of the blade 3700 and a base 2211 at a second end of the blade 3700. Thus, description of the similar features is omitted for ease of description. In contrast to the blade 2200, blade 3700 includes a single mounting tab 3701 that extends perpendicularly from a lower surface of the base 2211. The single mounting tab 3701 includes a hole 3703 to secure the blade 3700 to the hub 2700.

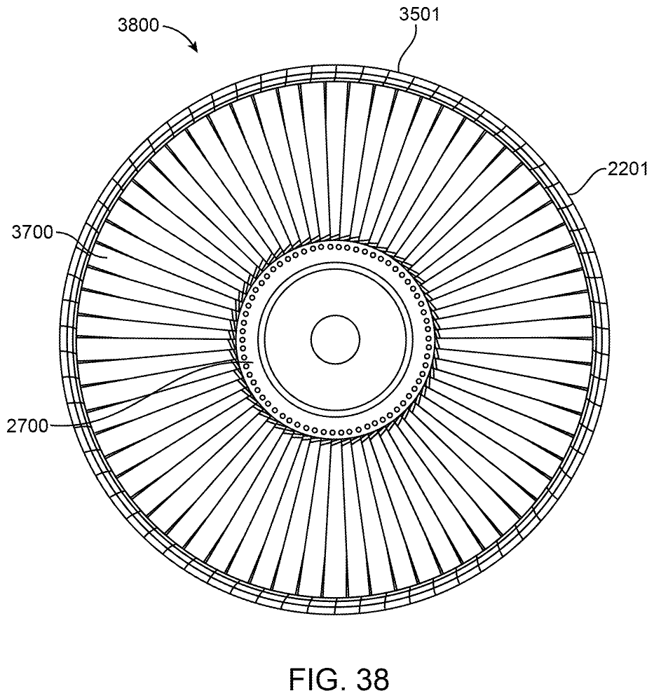

FIG. 38 illustrate a front view of a blade fan 3800 of the propulsor fan 100 according to one embodiment. The blade fan 3800 includes similar features as the blade fan 3500 such as a plurality of blades 3700 and a plurality of knife edge seals 3501 around the circumference of the blade fan 3800. Thus, description of the similar features is omitted for ease of description. In contrast to blade fan 3800, each blade 3700 attaches to the hub 2700 using a single fastener 3100 whereas the blades 2200 included in blade fan 3800 each require a plurality of fasteners 3100 to attach a single blade 2200 to the hub 2700 as previously described above.

Reference in the specification to “one embodiment” or to “an embodiment” means that a particular feature, structure, or characteristic is included in at least one embodiment of the disclosure. The appearances of the phrase “in one embodiment” in various places in the specification are not necessarily referring to the same embodiment.

While the disclosure has been particularly shown and described with reference to one embodiment and several alternate embodiments, it will be understood by persons skilled in the relevant art that various changes in form and details can be made therein without departing from the spirit and scope of the invention.

What is claimed is:

1. A propulsor fan comprising:
a hub including a first end and a second end;
a plurality of blades each including a first end of the blade, a second end that is opposite the first end of the blade, and an airfoil between the first end of the blade and the second end of the blade, wherein the second end of each blade includes a first mounting tab and a second mounting tab that are inserted into the hub;
a plurality of fasteners configured to connect the plurality of blades to the hub, wherein each fastener is configured to connect the first mounting tab of a first blade from the plurality of blades to the hub and the second mounting tab of a second blade from the plurality of blades to the hub, the second blade directly adjacent to the first blade;
one or more seals that protrude from an upper surface of the plurality of first ends of the plurality of blades, each of the one or more seals extending around a circumference of the blade fan;
a nose cone connected to the first end of the hub;
a motor connected to the second end of the hub; and
a duct that at least partially surrounds the blade fan, the hub, the nose cone, and the motor

2. A blade fan comprising:
a hub;
a plurality of blades each including a first end, a second end that is opposite the first end, and an airfoil between the first end and the second end, wherein the second end of each blade includes a first mounting tab and a second mounting tab that are inserted into the hub; and
a plurality of fasteners configured to connect the plurality of blades to the hub, wherein each fastener is configured to connect the first mounting tab of a first blade from the plurality of blades to the hub and the second mounting tab of a second blade from the plurality of blades to the hub, the second blade directly adjacent to the first blade.

3. The blade fan of claim 2, wherein the hub comprises:
a first end and a second end that is opposite the first end;
a plurality of mounting flanges that protrude from an upper surface of the hub that is between the first end of the hub and the second end of the hub, the plurality of mounting flanges including a first mounting flange and a second mounting flange toward the first end of the hub, and a third mounting flange and a fourth mounting flange toward the second end of the hub;
a plurality of slots around a circumference of the hub, the plurality of slots including a first slot between the first mounting flange and the second mounting flange, and a second slot between the third mounting flange and the fourth mounting flange; and
a plurality of holes in the plurality of mounting flanges, the plurality of holes including first holes in the first mounting flange, second holes in the second mounting flange, third holes in the third mounting flange, and fourth holes in the fourth mounting flange,
wherein a center of each of the first holes is aligned with a center of a corresponding one of the second holes, a center of a corresponding one of the third holes, and a corresponding one of the fourth holes.

4. The bladed fan of claim 4, wherein each of the first mounting flange, the second mounting flange, the third mounting flange, and the fourth mounting flange extend around a circumference of the hub.

5. The bladed fan of claim 3, wherein the first mounting tab of each of the plurality of blades include a first hole and the second mounting tab of each of the plurality of blades includes a second hole, and the first mounting tab and second mounting tab of each of the plurality of blades is offset from each other such that a center of the first hole in the first mounting tab is misaligned with a center of the second hole in the second mounting tab.

6. The bladed fan of claim 5, wherein the first mounting tab of each of the plurality of blades is inserted into the first slot and the second mounting tab of each of the plurality of blades is inserted into the second slot.

7. The bladed fan of claim 6, wherein the center of the first hole in the first mounting tab of each blade of the plurality of blades is aligned with a center of one of the first holes in the first mounting flange and a center of one of the second holes in the second mounting flange, and the center of the second hole in the second mounting tab of each blade of the plurality of blades is aligned with a center of one of the third holes in the third mounting flange and a center of one of the fourth holes in the fourth mounting flange,
wherein the center of the one of the first holes and the center of the one of the second holes that is aligned with the first hole of the first mounting tab of the blade are not aligned with the center of the one of the third holes and the center of the fourth holes that are aligned with the second hole of the second mounting tab of the blade.

8. The bladed fan of claim 6, wherein each fastener is configured to be inserted into the one of the first holes of the first mounting flange, the first hole in the first mounting tab of a corresponding blade, one of the second holes in the second mounting flange, one of the third holes in the third mounting flange, the second hole in the second mounting tab of another blade that is adjacent to the corresponding blade, and one of the fourth holes in the fourth mounting flange.

9. The bladed fan of claim of claim 2, wherein the second end of each of the plurality of blades further comprises:
a base including a lower surface, a first connection surface at a first side of the base, and a second connection surface at a second side of the base that is opposite the first side of the base, wherein the first mounting tab and the second mounting tab extend perpendicularly from the lower surface of the base away from the lower surface.

10. The bladed fan of claim 9, wherein the first connection surface of each of the plurality of blades is connected to the second connection surface of a first adjacent blade at the first side of the blade, and the second connection surface of each of the plurality of blades is connected to the first connection surface of a second adjacent blade at the second side of the blade.

11. The bladed fan of claim 2, wherein the first end of each of the plurality of blades comprises:
a shroud segment that is wider than a portion of the airfoil that is connected to the shroud segment, the shroud segment configured to connect to other shroud segments of other blades from the plurality of blades.

12. The bladed fan of claim 11, further comprising:
a tip shroud around a circumference of the blade fan, the shroud comprising interconnected shroud segments of the plurality of blades.

13. The bladed fan of claim 12, wherein the shroud segment of each of the plurality of blades includes a protrusion at a first side of the shroud segment and a recess at a second side of the shroud segment that is opposite the first side of the shroud segment, wherein the protrusion of each shroud segment is inserted into the recess of another shroud segment to connect the shroud segment to the other shroud segment.

14. The bladed fan of claim 12, wherein the first end of each of the plurality of blades further comprises:
a plurality of protrusions extending from an upper surface of the shroud segment of the blade and extending away from the upper surface of the shroud segment.

15. The bladed fan of claim 14, wherein each of the plurality of protrusions is connected to other protrusions of other blades from the plurality of blade to collectively form a plurality of seals along the upper surface of the tip shroud and around a circumference of the blade fan.

16. The bladed fan of claim 14, wherein each of the plurality of protrusions of each shroud segment includes side surfaces each having one or more steps.

17. The bladed fan of claim 14, wherein each of the plurality of protrusions of each shroud segment includes a first protrusion having a first height and a second protrusion having a second height that is a same as the first height.

18. The bladed fan of claim 14, wherein each of the plurality of protrusions of each shroud segment includes a first protrusion having a first height and a second protrusion having a second height that is different from the first height.

19. A blade fan comprising:
a hub including a first end and a second end that is opposite the first end;
a plurality of blades including a plurality of first ends, a plurality of second ends that are opposite the plurality of first ends and attached around a circumference of the hub, and a plurality of airfoils between the plurality of first ends and the plurality of second ends; and
one or more seals that protrude from an upper surface of the plurality of first ends of the plurality of blades, each of the one or more seals extending around a circumference of the blade fan.

20. The bladed fan of claim 19, wherein the first end of each of the plurality of blades comprises:
a shroud segment that is wider than a portion of an airfoil from the plurality of airfoils that is connected to the shroud segment, the shroud segment configured to connect to other shroud segments of other blades from the plurality of blades.

21. The bladed fan of claim 20, further comprising:
a shroud around a circumference of the blade fan, the shroud comprising interconnected shroud segments of the plurality of blades.

22. The bladed fan of claim 21, wherein the shroud segment of each of the plurality of blades includes a protrusion at a first side of the shroud segment and a recess at a second side of the shroud segment that is opposite the first side of the shroud segment, wherein the protrusion of each shroud segment is inserted into the recess of another shroud segment to connect the shroud segment to the other shroud segment.

23. The bladed fan of claim 21, wherein the one or more seals protrude from the upper surface of the shroud.

24. The bladed fan of claim 20, wherein the first end of each of the plurality of blades further comprises:
a plurality of protrusions extending from an upper surface of the shroud segment of the blade and extending away from the upper surface of the shroud segment,
wherein each of the plurality of protrusions of the shroud segment of the blade is configured to connect to other protrusions of other shroud segments of other blades from the plurality of blades to collectively form the one or more seals.

25. The bladed fan of claim 24, wherein each of the plurality of protrusions of each shroud segment includes side surfaces each having one or more steps.

26. The bladed fan of claim 24, wherein each of the plurality of protrusions of each shroud segment includes a first protrusion having a first height and a second protrusion having a second height that is a same as the first height.

27. The bladed fan of claim 24, wherein each of the plurality of protrusions of each shroud segment includes a first protrusion having a first height and a second protrusion having a second height that is different from the first height.

28. The bladed fan of claim 19, wherein the hub comprises:
a first end and a second end that is opposite the first end;
a plurality of mounting flanges that protrude from an upper surface of the hub that is between the first end of the hub and the second end of the hub, the plurality of mounting flanges including a first mounting flange and a second mounting flange toward the first end of the hub and a third mounting flange and a fourth mounting flange toward the second end of the hub;
a plurality of slots around the circumference of the hub, the plurality of slots including a first slot between the first mounting flange and the second mounting flange, and a second slot between the third mounting flange and the fourth mounting flange; and
a plurality of holes in the plurality of mounting flanges, the plurality of holes including first holes in the first mounting flange, second holes in the second mounting flange, third holes in the third mounting flange, and fourth holes in the fourth mounting flange,
wherein a center of each of the first holes is aligned with a center of a corresponding one of the second holes, a center of a corresponding one of the third holes, and a corresponding one of the fourth holes.

29. The bladed fan of claim 28, wherein each of the first mounting flange, the second mounting flange, the third mounting flange, and the fourth mounting flange extend around a circumference of the hub.

30. The bladed fan of claim 28, wherein the second end of each of the plurality of blades includes a first mounting tab and a second mounting tab that are inserted into the hub, the first mounting tab of each of the plurality of blades include a first hole and the second mounting tab of each of the plurality of blades includes a second hole, and the first mounting tab and second mounting tab of each of the plurality of blades is offset from each other such that a center of the first hole in the first mounting tab is misaligned with a center of the second hole in the second mounting tab.

31. The bladed fan of claim 30, wherein the first mounting tab of each of the plurality of blades is inserted into the first slot and the second mounting tab of each of the plurality of blades is inserted into the second slot.

32. The bladed fan of claim 31, wherein the center of the first hole in the first mounting tab of each blade of the plurality of blades is aligned with a center of one of the first holes in the first mounting flange and a center of one of the second holes in the second mounting flange, and the center of the second hole in the second mounting tab of each blade of the plurality of blades is aligned with a center of one of the third holes in the third mounting flange and a center of one of the fourth holes in the fourth mounting flange,
wherein the center of the one of the first holes and the center of the one of the second holes that is aligned with the first hole of the first mounting tab of the blade are not aligned with the center of the one of the third holes and the center of the fourth holes that are aligned with the second hole of the second mounting tab of the blade.

33. The bladed fan of claim 31, further comprising:
a plurality of fasteners configured to connect the plurality of blades to the hub, wherein each fastener is configured to connect the first mounting tab of a first blade from the plurality of blades to the hub and the second mounting tab of a second blade from the plurality of blades to the hub, the second blade directly adjacent to the first blade.
wherein each fastener is configured to be inserted into the one of the first holes of the first mounting flange, the first hole in the first mounting tab of a corresponding blade, one of the second holes in the second mounting flange, one of the third holes in the third mounting flange, the second hole in the second mounting tab of another blade that is adjacent to the corresponding blade, and one of the fourth holes in the fourth mounting flange.

34. The bladed fan of claim of claim 30, wherein the second end of each of the plurality of blades further comprises:
a base including a lower surface, a first connection surface at a first side of the base, and a second connection surface at a second side of the base that is opposite the first side of the base, wherein the first mounting tab and the second mounting tab extend perpendicularly from the lower surface of the base away from the lower surface.

35. The bladed fan of claim 34, wherein the first connection surface of each of the plurality of blades is connected to the second connection surface of a first adjacent blade at the first side of the blade, and the second connection surface of each of the plurality of blades is connected to the first connection surface of a second adjacent bade at the second side of the blade.

36. A propulsor configured to generate thrust, the propulsor comprising:
a hub including a first end and a second end that is opposite the first end;
a blade fan including a plurality of blades arranged in a circular ring where each blade includes a first end, a second end that is opposite the first end, and an airfoil between the first end and the second end, wherein the second end of each blade includes a first mounting tab and a second mounting tab that are inserted into a portion of the hub between the first end of the hub and the second end of the hub;
a plurality of fasteners configured to connect the blade fan to the hub, wherein each fastener is configured to connect the first mounting tab of a corresponding blade from the plurality of blades to the hub and the second mounting tab of another blade from the plurality of blades to the hub, the other blade directly adjacent to the corresponding blade;
a nose cone connected to the first end of the hub;
a motor connected to the second end of the hub; and
a duct that at least partially surrounds the blade fan, the hub, the nose cone, and the motor.

37. A propulsor configured to generate thrust, the propulsor comprising:
a hub including a first end and a second end that is opposite the first end;
a blade fan including a plurality of blades comprising a plurality of first ends, a plurality of second ends that are opposite the plurality of first ends and attached around a circumference of the hub, and a plurality of airfoils between the plurality of first ends and the plurality of second ends;
one or more seals that protrude from an upper surface of the plurality of first ends of the plurality of blades, each of the one or more seals extending around a circumference of the blade fan;
a nose cone connected to the first end of the hub;
a motor connected to the second end of the hub; and
a duct that at least partially surrounds the blade fan, the hub, the nose cone, and the motor.
